(19) United States
(12) Patent Application Publication
(10) Pub. No.: US 2009/0300665 A1
(43) Pub. Date: Dec. 3, 2009

(54) DISC DEVICE

(76) Inventors: Yusuke Akama, Saitama (JP); Hiroshi Yokota, Saitama (JP)

Correspondence Address: KRATZ, QUINTOS & HANSON, LLP, 1420 K Street, N.W., Suite 400, WASHINGTON, DC, 20005, US

(21) Appl. No.: 12/159,292

(22) PCT Filed: Dec. 26, 2006
(86) PCT No.: PCT/JP2006/325895

§ 371 Date: Aug. 16, 2009

(30) Foreign Application Priority Data
Dec. 27, 2005 (JP) 2005-376293

(51) Int. Cl. G11B 17/04

(52) U.S. Cl. 720/620; G9B/17.013

(57) ABSTRACT

The disc device includes a casing, a drive unit, a disc processor swingably supported in the casing, and a first shift cam that swings the disc processor. The first shift cam restricts the swing of the disc processor to place the disc processor to each of an escape state, a clamp state, and a standby state. The standby state is a state in which the optical disc clamped to the turntable is allowed to keep a position apart from the opposing face of the casing while the disc processor is swung from the escape state to the clamp state. Accordingly, with no need to detect the position in the standby state with an arrangement such as separately-provided sensor, the disc processor can be placed in such a swinging state that the turntable can be controlled to be slightly rotated during the double clamp operation in a simplified arrangement. While preventing clamp failures, the optical disc can be favorably processed.

### TECHNICAL FIELD

The present invention relates to a disc device for processing disc recording mediums.

### BACKGROUND ART

A disc device in which a turntable is elevated so that a disc is mounted thereon has conventionally been known (see, e.g., Patent Document 1).

The disc device disclosed in Patent Document 1 includes a disc attachment portion to which the disc is attached, a disc rotation drive mechanism for rotatably driving the disc, a base unit having a base on which the disc attachment portion and the disc rotation drive mechanism are integrally provided, and a substantially rectangular-parallelepiped-shaped drive lever for operating elevation and lowering of the base of the base unit. The base includes a first support shaft disposed on a lateral surface of the base facing the drive lever. A first cam slit with which the first support shaft of the base engages is formed along a longitudinal direction on a lateral surface of the drive lever facing the base.

The first cam slit includes a first horizontal surface, a top surface, and a second horizontal surface. The first horizontal surface is for locating the base to a chucking (clamp) disengagement position. The top surface is for locating the base to a chucking position. The second horizontal surface is for locating the base to an intermediate position. The first horizontal surface, the top surface, and the second horizontal surface are formed sequentially in a front-to-rear direction of the device. The chucking position is a position at which the disc located to a disc attachment position is attached to the disc attachment portion by elevating the base. The chucking disengagement position of the base is a position at which the disc is released from the disc attachment portion by lowering the base. The intermediate position is a position where the disc undergoes recording or reproduction of signals with the base being located between the chucking position and the chucking disengagement position.

In the disc device set forth above, the following chucking operations of the disc are conducted to securely attach the disc to the disc attachment portion. Initially, the disc is located at the disc attachment position. Subsequently, the drive lever is slid toward a rear side of the device to slide the first support shaft from the first horizontal surface to the top surface in the first cam slit. With this operation, the base is elevated from the chucking disengagement position to the chucking position, where the disc is attached to the disc attachment portion (a first chucking operation).

Next, the drive lever is slid toward the rear side of the device, where the first support shaft is slid from the top surface to the second horizontal surface in the first cam slit. With this operation, the base is lowered from the chucking position to the intermediate position. In this state, the disc is rotated by the disc rotation drive mechanism and undergoes a position adjustment.

Next, the drive lever is returned toward a front side of the device, where the first support shaft is slid from the second horizontal surface to the top surface in the first cam slit. The base is again elevated from the intermediate position to the chucking position, where the disc having undergone a phase adjustment is attached to the disc attachment portion (a second chucking operation).

Patent Document 1: JP-A-2005-251363 (see, e.g., pages 12 to 29 and FIGS. 5, 11 to 13, and 15)

### DISCLOSURE OF THE INVENTION

### Problems to Be Solved by the Invention

In a conventional disc device as disclosed in Patent Document 1, the clamp operation is conducted twice as set forth above. Here, the second clamp operation preferably includes sliding the support shaft from the second horizontal surface to the top surface in the first cam slit and further sliding the support shaft to a portion of the top surface adjacent to the first horizontal surface. With such an arrangement, the base can securely be elevated to the topmost of the chucking position. Accordingly, while disc clamping failure is prevented, the disc is more securely attached to the disc attachment portion.

However, in the conventional arrangement as disclosed in Patent Document 1, the second clamp operation does not include the sliding of the first support shaft to the portion of the top surface adjacent to the first horizontal surface. Consequently, a desirably reliable clamp operation may not be conducted. In addition, even if the first support shaft is slid to the portion of the top surface adjacent to the first horizontal surface, such sliding may cause the drive lever to be moved excessively toward the front side of the device, so that the first support shaft reaches the first horizontal surface. In this case, the clamping of the disc may undesirably be disengaged. Should such disengagement be avoided, the drive lever needs to change its moving direction to the opposite direction at a position between the first horizontal surface and the top surface where the clamp of the disc is not disengaged, but it may be difficult to detect the appropriate position for the lever to turn back.

With regards to the above problems, an object of the present invention is to provide a disc device capable of favorably clamping a disc-shaped recording medium.

### Means for Solving the Problems

A disc device according to an aspect of the present invention includes: a casing with a slit-shaped opening through which a disc-shaped recording medium is adapted to be inserted and ejected; a drive unit provided in the casing; a traverse body comprising a turntable for detachably clamping the recording medium and an information processor that conducts an information processing comprising at least one of recording processing for recording information on the recording medium clamped on the turntable and reading processing for reading the information stored on the recording medium, the traverse body being supported in the casing and adapted to be swung so that the turntable advances to and retreats from a transfer course along which the recording medium inserted from the opening is transferred into the casing; and a swing unit that is disposed in the casing, engaged with the traverse body, and moved by the drive unit to swing the traverse body, in which the swing unit restricts the swinging of the traverse body so that the traverse body becomes each of an escape state in which the turntable is escaped from the transfer course, a clamp state in which the recording medium is clamped to the turntable while being abutted to an inner surface of the casing opposite to the turntable, and a standby state in which the recording medium clamped to the turntable can keep a position spaced apart from the inner surface of the casing white the traverse body is swung from the escape state to the clamp state.

### BRIEF DESCRIPTION OF DRAWINGS

FIG. 1 is a top view showing an interior arrangement of a disc device as a recording medium drive in an initial state according to the present invention.

FIG. 2 is a top view showing an arrangement of a loading unit of the disc device.

FIG. 3 is a top view showing an arrangement of the loading unit and a clamper of the disc device.

FIG. 4 is a side view showing a side of a first shift cam of the clamper of the disc device.

FIG. 5 is a top view showing the inside of the disc device when a large-diameter disc is to be inserted.

FIG. 6 is a top view showing the inside of the disc device while the large-diameter disc is being transferred.

FIG. 7 is a top view showing the inside of the disc device when the large-diameter disc is completely loaded.

FIG. 8 is a top view showing the inside of the disc device when the large-diameter disc has been clamped.

FIG. 9 is a top view showing the inside of the disc device when the large-diameter disc has been unloaded.

FIG. 10 is a top view showing the inside of the disc device when a small-diameter disc is to be loaded and when the small-diameter disc has been unloaded.

FIG. 11 is a top view showing the inside of the disc device while the small-diameter disc is being transferred.

FIG. 12 is a top view showing the inside of the disc device when the small-diameter disc has been loaded.

FIG. 13 is a top view showing the inside of the disc device when the small-diameter disc has been clamped.

FIG. 14 is a timing chart of a first to fourth switches in accordance with progress in transfer of the large-diameter disc.

FIG. 15 is a timing chart of a first to fourth switches in accordance with progress in transfer of the small-diameter disc.

FIG. 16 is a side view showing a right-wall side of a first shift cam of the clamper of the disc device.

### EXPLANATION OF CODES

1 . . . optical disc (a recording medium)
1A . . . large-diameter disc (a recording medium)
1A . . . small-diameter disc (a recording medium)
100 . . . disc device
10 . . . casing
14 . . . insertion-and-ejection opening (opening)
20 . . . disk processor (traverse body)
21C . . . clamper elevating pin
23 . . . turntable
24 . . . information processor
30 . . . transfer unit
40 . . . drive unit (drive unit)
41 . . . drive motor (drive source)
422 . . . shift drive branch gear (swing-side transmission mechanism)
423 . . . roller drive branch gear (transfer-side transmission mechanism)
613 . . . cam pushing pin (pushing member)
71 . . . first shift cam (swing unit)
715 . . . clamper elevating groove
715A . . . escape section
715B . . . standby section 715C . . . clamp section
715D . . . in-process section
SW4 . . . fourth switch (processing-state detector)

### BEST MODE FOR CARRYING OUT THE INVENTION

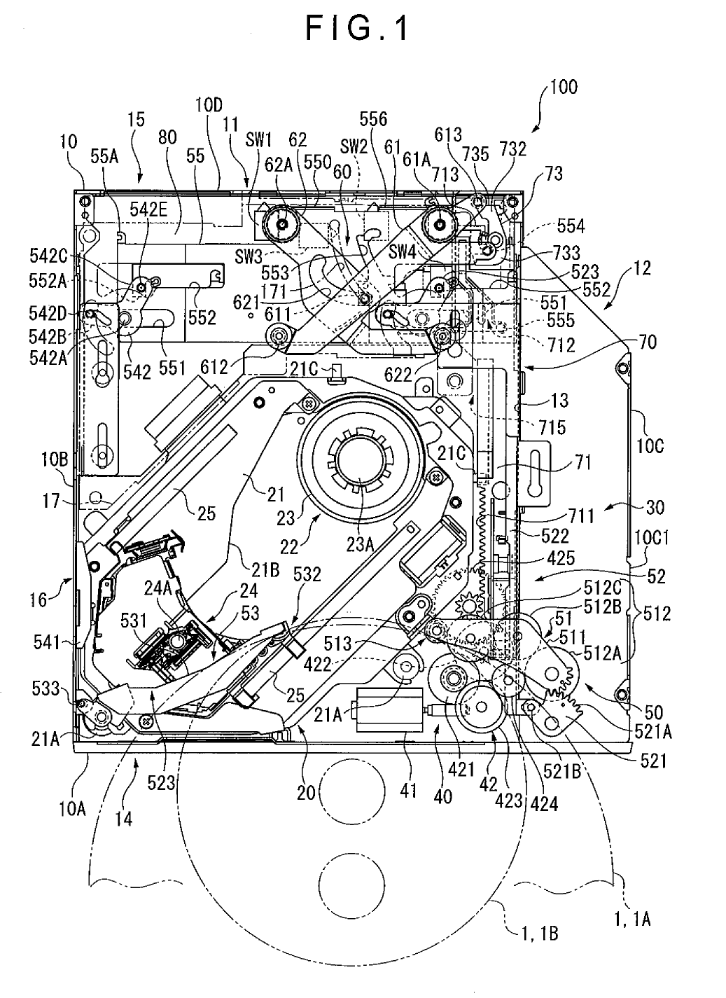

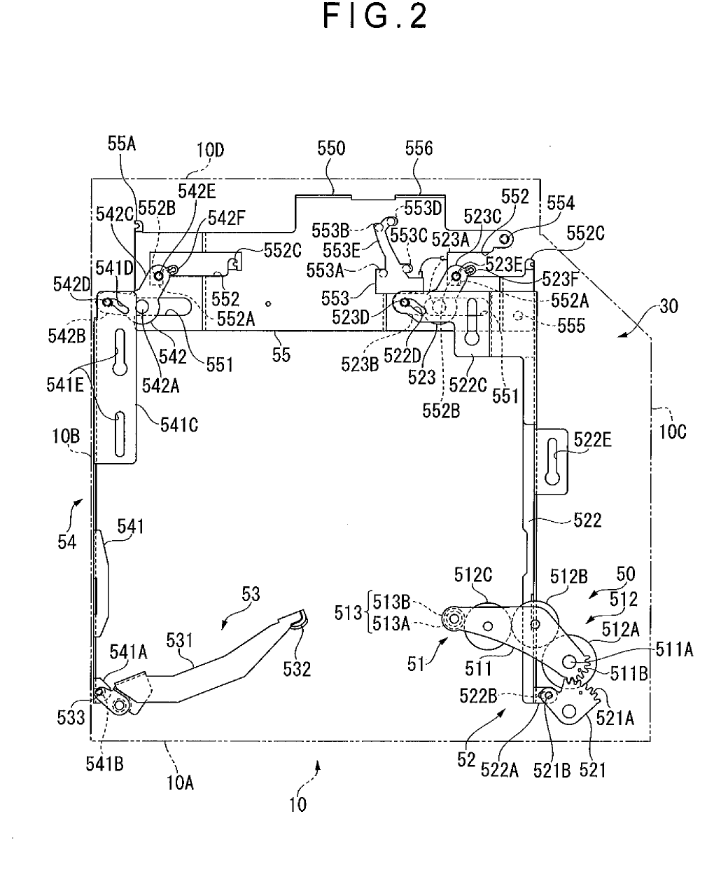

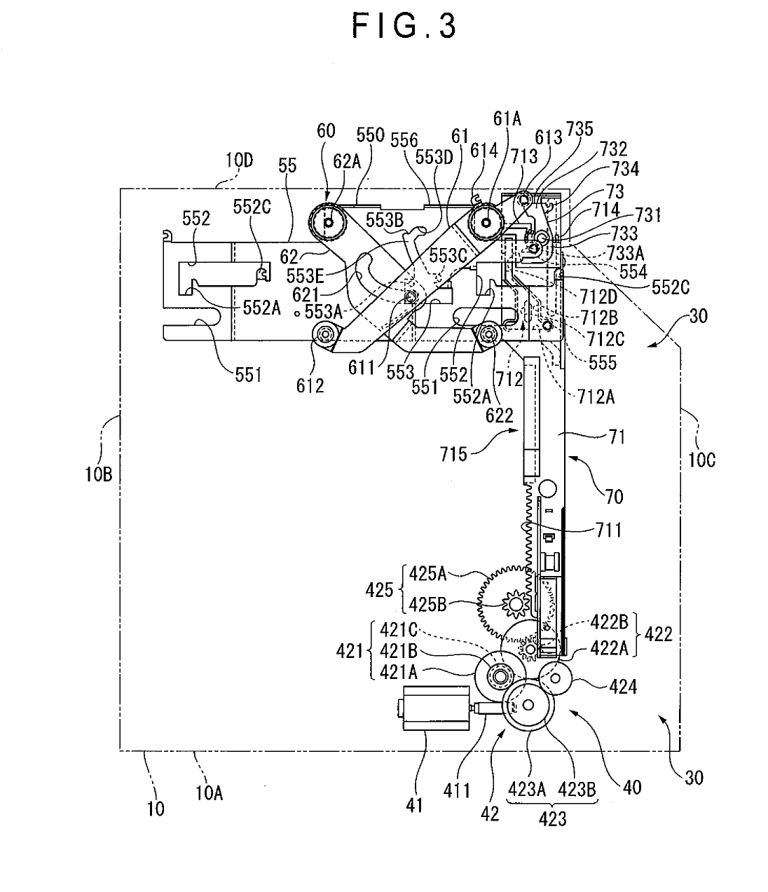

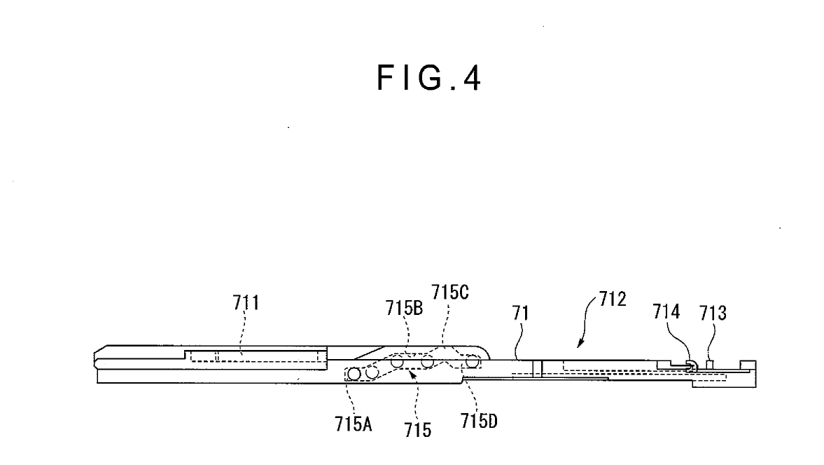

A disc device according to an embodiment of the present invention will be described below with reference to the attached drawings. FIG. 1 is a top view showing an initial interior arrangement of the disc device as a recording medium drive according to the present invention. FIG. 2 is a top view showing an arrangement of a loading unit of the disc device. FIG. 3 is a top view showing an arrangement of the loading unit and a clamper of the disc device. FIG. 4 is a side view showing a right-wall side of a first shift cam of the clamper of the disc device.

Arrangement of Disc Device

In FIG. 1, the numeral 100 denotes a disc device serving as a recording medium drive according the embodiment of the present invention. The disc device 100 performs such information processing as reading-processing or recording-processing on an optical disc 1 (disc recording medium), thereby reading information recorded on a recording surface (not shown) provided on at least one surface of the optical disc 1 or recording a variety of information on the recording surface of the optical disc 1. The disc device 100 is a so-called thin slot-in disc device attached to, for instance, an electric equipment such as a notebook personal computer of which thickness is relatively limited. Incidentally, though the thin disc device 100 attached to a notebook personal computer is exemplified in the present embodiment, the disc device 100 may alternatively be installed in, for instance, a gaming machine, a video device for recording/reproducing image data, and the like. Further, the disc device 100 may perform only one of the reading processing and recording processing.

In addition, the disc device 100 can accept a large-diameter disc 1A having 12 cm diameter and a small-diameter disc 1B having 8 cm diameter as the optical disc 1. The disc recording medium is not limited to the optical disc 1 but may be any other disc recording medium such as a magnetic disc or a magnetic optical disc.

The disc device 100 includes a substantially box-shaped casing 10 having an inner space, an exemplary material of which is a metal. In the casing 10, a lower side of the casing 10 shown in FIG. 1 may be referred to as a front face 10A, a left lateral wall of the casing 10 shown in FIG. 1 may be referred to as a left wall 10B, a right lateral wall of the casing 10 shown in FIG. 1 may be referred to as a right wall 10C and an upper side in FIG. 1 may be referred to as a rear face 10D.

The casing 10 includes a casing body 11 and a wing 12 provided on the right side of the casing body 11 in FIG. 1. The top faces of the casing body 11 and the wing 12 are flush with each other while the bottom faces thereof are located at different heights. Specifically, the distance from the top face to the bottom face of the wing 12 is smaller than that of the casing body 11. A stepped wall 13 rising from the bottom face of the casing body 11 to connect the bottom faces of the casing body 11 and the wing 12 is provided on the casing body 11 near the right wall 10C.

The front face 10A of the casing 10 is provided with an insertion-and-ejection opening 14 for inserting/ejecting the optical disc 1, the insertion-and-ejection opening 14 extending from the casing body 11 to the wing 12 in the right-and-left direction of FIG. 1. A connector section 15 is provided on the rear face 10D of the casing 10 near the left wall 10B. The connector section 15 is adapted to be connected with an external equipment (e.g. a personal computer) arranged outside the disc device 100, to which a plug for transmitting/receiving various information from the external equipment or feeding/receiving electric power is connected.

The casing 10 internally includes a disc processor 20 (a traverse body of the present invention), a transfer unit 30 for transferring the optical disc 1, and a control circuit 80.

The disc processor 20 longitudinally extends from a position near the insertion-and-ejection opening 14 of the casing 10, i.e. from the front face 10A on the side of the left wall 10B approximately toward the center of the casing 10. The disc processor 20 includes a plate-like base 21 that longitudinally extends substantially in the same direction as the longitudinal direction of the disc processor 20, an exemplary material of which is metal plate.

The base 21 is attached via an elastic floating rubber 21A provided near the insertion-and-ejection opening 14 on the side of the left wall 10B in a manner pivotally movable relative to the casing 10. In other words, the base 21 is pivotally movable around the attachment position near the insertion-and-ejection opening 14 on the side of the left wall 10B. The base 21 is longitudinally cut out to substantially centrally form a longitudinal processor opening 21B. A disc rotation driver 22 is disposed near a first end of the processor opening 21B of the base 21, i.e., substantially at the center of the casing 10. The disc rotation driver 22 includes a spindle motor (information processor: not shown), and a turntable 23 provided integrally with an output shaft of the spindle motor. The spindle motor is controllably connected to the control circuit 80 and driven by electricity supplied from the control circuit 80. The turntable 23, which is provided substantially at the center inside the casing 10, is rotated with the optical disc 1 being disposed thereon.

At the center of the turntable 23, a disc engaging portion 23A for engaging with or disengaging from a centerhole (circular hole) provided at the center of the optical disc 1 protrudes toward the top face. Claw members (not shown) that protrude toward the top face with the optical disc 1 being engaged with the disc engaging portion 23A to prevent detachment of the optical disc 1 are provided around the disc engaging portion 23A.

The base 21 includes an information processor 24. The information processor 24, which is supported by a pair of guide shafts 25 while bridging the guide shafts 25, is moved toward and away from the turntable 23 within the processor opening 21B by a moving mechanism (not shown). The information processor 24 has a pickup mechanism that includes: a light source (not shown); a pick-up lens 24A for converging light of the light source; and a light sensor (not shown) for detecting specular light reflected from the optical disc 1. The information processor 24 is located on the base 21 near the front face 10A except when the optical disc 1 is held on the turntable 23 (processable state), which is moved toward and away from the turntable 23 after the optical disc 1 is held by the turntable 23.

The transfer unit 30 loads the optical disc 1 inserted from the insertion-and-ejection opening 14 into the inside of the casing 10, mounts the loaded optical disc 1 onto the turntable 23 of the disc processor 20 and unloads the optical disc 1 inside the casing 10 to the outside. The transfer unit 30 includes a drive unit 40 (driver), a loading unit 50, an unloading unit 60, a disc clamper 70 and the like.

The drive unit 40 feeds a drive power for driving the respective components of the transfer unit 30. The drive unit 40 includes a drive motor 41 (drive source) and drive transmission gears 42.

The drive motor 41 is disposed near the insertion-and-ejection opening 14 of the front face 10A of the casing 10 in a space formed between the disc processor 20 and the stepped wall 13, which is a dead space formed by the provision of the disc processor 20.

The drive motor 41 is electrically connected with the control circuit 80, which rotates a rotary shaft thereof in accordance with a control signal from the control circuit 80. A worm gear 411 is provided at a tip end of the rotary shaft. The worm gear 411 transmits a rotary drive force to the drive transmission gears 42.

The drive transmission gears 42 include a first transmission gear 421, a shift drive branch gear 422 (swing-side transmission mechanism), a roller drive branch gear 423 (transfer-side transmission mechanism), a second transmission gear 424 and a cam shift gear 425.

The first transmission gear 421 includes: a first large-diameter transmission gear 421A; a first top-side small-diameter transmission gear 421B having a smaller diameter and coaxially integrated on a top side of the first large-diameter transmission gear 421A; and a first bottom-side small-diameter transmission gear 421C having a smaller diameter and integrated on a bottom side of the first large-diameter transmission gear 421A. The first large-diameter transmission gear 421A is meshed with the worm gear 411 to convert the rotary drive force of the drive motor 41 into an axial force orthogonal to the bottom of the casing 10. The first bottom-side small-diameter transmission gear 421C provided on the bottom side of the first large-diameter transmission gear 421A is meshed with the shift drive branch gear 422. The first top-side small-diameter transmission gear 421B provided on the top side of the first large-diameter transmission gear 421A is meshed with the roller drive branch gear 423. With this arrangement, the first transmission gear 421 transmits the rotary drive force from the drive motor 41 to the shift drive branch gear 422 and the roller drive branch gear 423.

The shift drive branch gear 422 includes a large-diameter shift drive branch gear 422A and a drive branch pinion 422B coaxially integrated on the bottom side of the large-diameter shift drive branch gear 422A. The large-diameter shift drive branch gear 422A is meshed with the first bottom-side small-diameter transmission gear 421C. The drive branch pinion 422B is meshed with the cam shift gear 425. With this arrangement, the shift drive branch gear 422 transmits the rotary drive force transmitted from the first transmission gear 421 to the cam shift gear 425. The shift drive branch gear 422 is rotatably provided on the bottom face of the casing body 11. The thickness of the shift drive branch gear 422 from the bottom face of the casing body 11 to the top face of the large-diameter shift drive branch gear 422A is smaller than the height of the stepped wall 13. Accordingly, a space is provided between the top side of the shift drive branch gear 422 and the bottom face of the wing 12, which serves as a movement path of below-described first shift cam 71.

The roller drive branch gear 423 includes a large-diameter roller drive branch gear 423A and a small-diameter roller drive branch gear 423B coaxially integrated on the top side of the large-diameter roller drive branch gear 423A. The large-diameter roller drive branch gear 423A is meshed with the first top-side small-diameter transmission gear 25421B. The small-diameter roller drive branch gear 423B is meshed with the second transmission gear 424. With this arrangement, the roller drive branch gear 423 transmits the rotary drive force transmitted from the first transmission gear 421 to the second transmission gear 424. The roller drive branch gear 423 is provided on the bottom face of the casing body 11 substantially at the same height as that of the bottom face of the wing 12. Accordingly, a space is provided between the bottom face of the roller drive branch gear 423 and the bottom face of the casing body 11, which serves as a movement path of the first shift cam 71.

The second transmission gear 424 is provided on a support piece projecting from the bottom face of the wing 12 toward the left wall 10B. The second transmission gear 424 is meshed with the small-diameter roller drive branch gear 423B and a below-described loading arm 51 of the loading unit 50. With this arrangement, the second transmission gear 424 transmits the rotary drive force transmitted from the roller drive branch gear 423 to the loading arm 51.

The cam shift gear 425 includes a large-diameter shift gear 425A with larger diameter and a pinion gear 425B with smaller diameter, the pinion gear 425B being coaxially integrated on the top side of the large-diameter shift gear 425A. The large-diameter shift gear 425A is provided on the bottom side of the first shift cam 71, i.e. between the casing body 11 and the first shift cam 71. The pinion gear 425B is provided on an advancement-retraction movement path of a below-described rack 711 provided on an end face of the first shift cam 71. The large-diameter shift gear 425A is meshed with the drive branch pinion 422B of the shift drive branch gear 422. On the other hand, the pinion gear 425B is provided in a manner capable of being meshed with the below-described first shift cam 71 of the disc clamper 70.

As shown in FIG. 2, the loading unit 50 is driven by a drive force fed by the drive unit 40 to load the optical disc 1 inserted from the insertion-and-ejection opening 14 into the casing 10. The loading unit 50 includes the loading arm 51, a loading link mechanism 52, a disc guide arm 53, a disc guide link mechanism 54 and a link plate 55.

The loading arm 51 is longitudinally provided. A first end of the loading arm 51 is rotatably provided near the insertion-and-ejection opening 14 of the wing 12 while a second end of the loading arm 51 is capable of advancing and retracting relative to the center of the casing 10. The loading arm 51 is provided with a roller 513 capable of holding the optical disc 1 on a distal end thereof. The loading arm 51 transfers the optical disc 1 along a transfer course in accordance with the rotation of the roller 513.

The loading arm 51 is rotated toward the right wall 10C to a position capable of guiding the optical disc 1 in accordance with the diameter of the optical disc 1 to be transferred. In other words, when, for instance, a large-diameter disc 1A is to be transferred, the loading arm 51 is rotated near to the right wall 10C. On the other hand, when a small-diameter disc 1B is to be transferred, the loading arm 51 is rotated to a position capable of transferring the small-diameter disc 1B, i.e. to a position where a distance between a centerline extended forward and backward from the rotary center of the turntable 23 and the roller 513 becomes approximately 4 cm. In contrast, when the disc processor 20 is moved toward the top side to clamp the optical disc 1 onto the turntable 23 (playable state), the loading arm 51 is rotated toward the right wall 10C so that the roller 513 is spaced apart from the periphery of the optical disc 1. The loading arm 51 includes a longitudinal loading arm body 511, a roller drive 512 provided on the loading arm body 511 and the above-described roller 513.

The loading arm body 511 is a plate member longitudinally extending along the longitudinal direction of the loading arm 51. A support portion 511A is provided on a base end of the loading arm body 511. The bottom face of the support portion 511A is rotatably supported by a shaft protruding from the bottom face of the wing 12 toward the top face, so that a distal end of the loading arm body 511 is capable of advancing and retracting toward the inside of the casing 10. A proximal end of the loading arm body 511 is provided by an arc of a predetermined diameter around the support portion 511A. A first gear 511B is provided along the arc. A roller attachment hole (not shown) for attaching the roller 513 is provided on a distal end of the loading arm body 511.

The roller drive 512 is provided on a bottom side of the loading arm body 511. The roller drive 512 includes a first roller drive gear 512A rotated around a shaft for supporting the support portion 511A of the loading arm body 511, a second roller drive gear 512B meshed with the first roller drive gear 512A, and a third roller drive gear 512C meshed with the second roller drive gear 512B. The first roller drive gear 512A is meshed with the second transmission gear 424 of the drive unit 40 from which the drive force from the drive unit 40 is transmitted. The third roller drive gear 512C is meshed with the roller 513 to transmit the drive force transmitted from the drive unit 40 to the roller 513 through the first and second roller drive gears 512A, 512B.

The first to the third roller drive gears 512A, 512B, 512C have a thickness substantially the same as or slightly smaller than a gap between the loading arm body 511 and the wing 12, so that the first to the third roller drive gears 512A, 512B, 512C do not interfere with the wing 12 when the loading arm 51 is rotated.

The roller 513 is rotatably attached to the roller attachment hole on the distal end of the loading arm body 511. The roller 513 includes a roller gear 513A provided on the bottom side of the loading arm body 511, and a roller body 513B provided on the top side of the loading arm body 511. The roller gear 513A and the roller body 513B are integrated by a shaft penetrating the roller attachment hole of the loading arm body 511.

The roller gear 513A is meshed with the third roller drive gear 512C to be rotated by a rotation of the third roller drive gear 512C.

The roller body 513B is a substantially cylindrical member with an axis extending in a direction substantially orthogonal to a surface of the loading arm body 511. The roller body 513B has a recessed portion with smaller diameter at an axially central portion than that on the top and bottom sides of the roller body 513B. A circumference of the roller body 513B is formed of an elastic member such as synthetic resin. The roller body 513B is rotated while holding the periphery of the optical disc 1 with the recessed portion, thereby advancing and retracting the optical disc 1 along the transfer course.

When a largest-diameter section of a large-diameter disc 1A passes the roller 513 in transferring the large-diameter disc 1A, the loading arm 51 is moved at the maximum toward the right wall 10C. At this time, the roller 513 is inserted to an escape hole 10C1 provided on the right wall 10C of the casing 10.

The loading link mechanism 52 includes a loading link arm 521, a loading slide plate 522 and a loading link lever 523

The loading link arm 521 is rotatably provided on the bottom face of the wing 12. The loading link arm 521 is provided approximately as a sector, along an arc of which a second gear 521A engaged with the first gear 511B of the loading arm body 511 is provided. A loading link pin 521B protruding toward the bottom face of the wing 12 is provided on an inner side of the second gear 521A (i.e. on the left wall 10B side) of the loading link arm 521.

The loading slide plate 522 opposes to the stepped wall 13 and longitudinally extends in front-and-back direction (in a direction from the front face 10A to the rear face 10D of the casing 10). A first loading link engaging portion 522A that protrudes from a top-side periphery of the loading slide plate 522 toward the right wall 10C to oppose to the bottom face of the wing 12 is provided on the side of the front face 10A of the loading slide plate 522.

A loading engaging groove 522B longitudinal in right-and-left direction is provided on the first loading link engaging portion 522A. The loading link pin 521B of the loading link arm 521 is engaged with the loading engaging groove 522B. When the loading link arm 521 is rotated in accordance with the rotation of the loading arm 51, the loading link pin 521B advances and retracts forward and backward, so that the loading slide plate 522 slides forward and backward in accordance with the movement of the loading link pin 521B.

A second loading link engaging portion 522C protruding toward the inside of the casing is provided on the rear-face-10D side of the loading slide plate 522. A second loading engaging groove 522D that extends from a left-wall-10B side toward the front face 10A side of the right wall 10C is provided on the second loading link engaging portion 522C.

A loading guide groove 522E extending forward and backward is provided approximately at the center of front-and-back direction of the loading slide plate 522 to define the slide movement direction of the loading slide plate 522.

As shown in FIG. 2, the loading link lever 523 is provided with a first lever 523B and a second lever 523C that extend from a rotary shaft 523A at a predetermined angle with each other.

The rotary shaft 523A is rotatably attached on the bottom face of the top plate 17. A first lever pin 523D protrudes from a distal end of the first lever 523B toward the top face. The first lever pin 523D is engaged with the second loading engaging groove 522D of the second loading link engaging portion 522C of the loading slide plate 522. With this arrangement, when the loading slide plate 522 slides toward the front face 10A, the first lever pin 523D also moves toward the front face 10A, thereby rotating the loading link lever 523 anticlockwise. On the other hand, when the loading slide plate 522 slides toward the rear face 10D, the first lever pin 523D also moves toward the rear face 10D, thereby rotating the loading link lever 523 clockwise.

The second lever pin 523E protrudes from the distal end of the second lever 523C toward the bottom face. The second lever pin 523E is engaged with the below-described link plate 55. A spring mount 523F is provided on a distal end of the second lever 523C, which receives a spring (not shown) wound against the link plate 55. Accordingly, anticlockwise biasing force is constantly applied on the loading link lever 523. A spring mount 55A is provided on the link plate 55, which receives a spring (not shown) wound against the top plate 17. Accordingly, the link plate 55 is always biased toward the right wall 10C. Specifically, the loading slide plate 522 is constantly biased toward the rear face 10D and the distal end of the loading arm 51 is biased toward move to the center of the casing 10.

The disc guide arm 53 is longitudinally formed, whose base end is rotatably mounted in the vicinity of the left wall 10B adjacent to the front face 10A (i.e., near the insertion-and-ejection opening 14). With this arrangement, the distal end of the disc guide arm 53 can advance toward or retract from the center of the casing 10. Further, the disc guide arm 53 is curved inward at a section between the base end and the distal end. Specifically, a mount 16 for attaching the disc device 100 to, for instance, a personal computer is provided on the left wall 10B on the side of the front face 10A and the disc guide arm 53 stays off from the mount by the curved section 531. Accordingly, when the disc guide arm 53 is rotated to the nearest position to the left wall 10B, the distal end of the disc guide arm 53 does not protrude over the disc processor 20, so that interference between the information processor 24 and the disc guide arm 53 can be avoided during the processable state.

A disc guide 532 that protrudes toward the bottom side is provided on the distal end of the disc guide arm 53. The disc guide 532 is a semicylindrical member having an axis vertically extending from the bottom side to the top side, which has an arc-shaped section on an inward side thereof. When the optical disc 1 is transferred, the disc guide 532 is in contact with the periphery of the optical disc 1 to be transferred to hold the optical disc 1 together with the roller 513 of the loading arm 51. When the largest-diameter section of the large-diameter disc 1A passes the disc guide arm 53, the disc guide arm 53 is rotated to a position most adjacent to the left wall 10B. However, since the disc guide 532 is provided as a semicylindrical member, the disc guide 532 and the left wall 10B do not interfere with each other. Accordingly, the transfer of the optical disc 1 can be guided without enlarging the horizontal width of the disc device 100, thereby providing a disc device adapted for size reduction.

Further, a disc guide pin 533 that protrudes toward the bottom face is provided on the base end of the disc guide arm 53 near the left wall 10B. The disc guide pin 533 moves toward the front face 10A when the disc guide arm 53 is rotated toward the left wall 10B. In contrast, when the disc guide arm 53 moves toward the right wall 10C, the disc guide pin 533 moves toward the rear face 10D.

Like the loading arm 51, the disc guide arm 53 is rotated toward the left wall 10B to a position capable of guiding the optical disc 1 in accordance with the diameter of the optical disc 1 to be transferred. For instance, when a large-diameter disc 1A is to be transferred, the disc guide arm 53 is rotated to a position near the left wall 10B. On the other hand, when a small-diameter disc 1B is to be transferred, the disc guide arm 53 is rotated toward the left wall 10B to a position where a distance between the disc guide 532 and a centerline extended forward and backward from the rotary center of the turntable 23 becomes approximately 4 cm Further, the disc guide arm 53 is rotated close to the left wall 10B during the playable state, so that the disc guide 532 is spaced apart from the periphery of the optical disc 1.

The disc guide link mechanism 54 includes a disc guide slide plate 541 and a disc guide link lever 542.

The disc guide slide plate 541 opposes to the left wall 10B and longitudinally extends in the front-and-back direction A first disc guide link engaging portion 541A that extends from a bottom-side periphery to the rotary shaft of the disc guide arm 53 is provided on the disc guide slide plate 541 near the front face 10A. A horizontally longitudinal first disc guide link groove 541B is provided on the first disc guide link engaging portion 541A, with which the disc guide pin 533 is engaged. The disc guide slide plate 541 slides forward and backward in accordance with the movement of the disc guide pin 533 in the front-and-back direction caused by the rotation of the disc guide arm 53.

A second disc guide link engaging portion 541C protruding toward the inside of the casing 10 is provided on the disc guide slide plate 541 near the rear face 10D. A second disc guide engaging groove 541D that is slanted from the left side toward the front right side is provided on the second disc guide link engaging portion 541C.

A loading guide groove 541E extending forward and backward is provided approximately at the center of front-and-back direction of the disc guide slide plate 541 to guide the slide movement direction of the disc guide slide plate 541.

The disc guide link lever 542 is rotatable around a rotary shaft 542A provided on the bottom face of the top plate 17. The disc guide link lever 542 is provided with a first guide lever 542B and a second guide lever 542C that extend from the rotary shaft 542A at a predetermined angle with each other. A first guide lever pin 542D protrudes from a distal end of the first guide lever 542B toward the top face. The first guide lever pin 542D is engaged with the second disc guide engaging groove 541D of the second disc guide link engaging portion 541C. Accordingly, when the disc guide slide plate 541 slides toward the front face 10A, the first guide lever pin 542D also moves toward the front face 10A, thereby rotating the disc guide link lever 542 anticlockwise. On the other hand, when the disc guide slide plate 541 slides toward the rear face 10D, the first guide lever pin 542D also moves toward the rear face 10D, thereby rotating the disc guide link lever 542 clockwise.

A second guide lever pin 542E protrudes from the distal end of the second guide lever 542C to the bottom face. The second guide lever pin 542E is engaged with the below-described link plate 55. A spring mount 542F is provided on the distal end of the second guide lever 542C, which receives a spring (not shown) wound against the link plate 55. Accordingly, anticlockwise biasing force is constantly applied on the disc guide link lever 542. Specifically, the disc guide slide plate 541 is constantly biased toward the rear face 110D and the distal end of the disc guide arm 53 is biased to move toward the center of the casing 10.

The link plate 55 is provided on the casing 10 near the rear face 10D, which is a plate member that extends in the right-and-left direction. The link plate 55 is movable in the right and left directions in accordance with the movement of the loading arm 51 and the disc guide arm 53. When the optical disc 1 is not inserted (i.e., initial state), the link plate 55 is disposed nearest to the right wall 10C. The link plate 55 includes link guide grooves 551, lever engaging windows 552, an eject-restricting window 553, a select pin 554 and a cam control pin 555.

The link guide grooves 551 are provided on both of right and left ends of the link plate 55 at positions where the distances from the rear face 10D become substantially equal to each other to extend in right-and-left direction. The link guide grooves 551 respectively receive the above-described rotary shafts 523A and 542A of the loading link lever 523 and the disc guide link lever 542. With this arrangement, the movement of the link plate 55 is set in right-and-left direction.

The lever engaging windows 552 are provided on the link plate 55 adjacent to the rear face 10D, and located in the vicinity of the link guide grooves 551 provided on the right and left of the link plates 55. The lever engaging windows 552 include lever pin engaging portions 552A with which the second lever pin 523E of the loading link lever 523 and the second guide lever pin 542E of the disc guide link lever 542 are engaged respectively.

The lever pin engaging portions 552A are grooves extending in the front-and-back direction, which respectively receive the second lever pin 523E and the second guide lever pin 542E. When the second lever pin 523E and the second guide lever pin 542E are moved to push the right and left walls of the lever pin engaging portions 552A, the link plate 55 slides in right and left direction.

Further, the dimensions of the grooves in right and left direction of the lever pin engaging portions 552A are slightly larger than the diameter of the second lever pin 523E and the second guide lever pin 542E. Accordingly, a gap 552B is provided in right and left direction between the second lever pin 523E/the second guide lever pin 542E and the lever pin engaging portion 552A.

The gap 552B is a rotation play that allows the loading link lever 523 and the disc guide link lever 542 to escape when, for instance, an impact is applied on the disc device 100 while transferring the optical disc 1. In other words, in an arrangement where there is no gap 552B therebetween, when an impact is applied to, for instance, move the loading arm 51 toward the right wall 10C, the disc guide arm 53 is also moved toward the left wall 10B in accordance with the movement. Accordingly, the periphery of the optical disc 1 cannot be held by the loading arm 51 or the disc guide arm 53 so that the optical disc 1 may fall off to cause a malfunction. In contrast, when the gap 552B is provided, even when the loading arm 51 is slightly moved toward the right wall 10C with an impact applied, the disc guide arm 53 is not moved, thereby preventing the optical disc 1 from falling off.

Further, spring-engaging portions 552C are respectively provided on the lever engaging windows 552 on the sides of the right wall 10C. Springs (not shown) are provided between the spring-engaging portions 552C and the spring mounts 523F, 542F, which bias clockwise the loading link lever 523 and the disc guide link lever 542.

The eject-restricting window 553 is a window provided approximately at the center of the link plate 55. The eject-restricting window 553 restricts the movement of a below-described first eject arm 61 of the unloading unit 60. The eject-restricting window 553 includes a small-diameter restricting/engaging portion 553A, a large-diameter restricting/engaging portion 553B, a small-diameter spacing/engaging portion 553C and a large-diameter spacing/engaging portion 553D. Further, an eject pin 611 provided on the first eject arm 61 is inserted through the eject-restricting window 553. The small-diameter restricting/engaging portion 553A, the large-diameter restricting/engaging portion 553B, the small-diameter spacing/engaging portion 553C and the large-diameter spacing/engaging portion 553D are in communication with each other so that the eject pin 611 can be moved therein to be engaged/disengaged with the respective portions. The engagement/disengagement of the eject pin 611 and the portions 553A, 553B, 553C, 553D changes in accordance with right-and-left slide movement of the link plate 55 in conjunction with the loading arm 51 and the disc guide arm 53.

The small-diameter restricting/engaging portion 553A is provided on the eject-restricting window 553 adjacent to the front face 10A and the left wall 10B. The eject pin 611 is engaged with the small-diameter restricting/engaging portion 553A when a small-diameter disc 1B is ready to be held by the turntable 23 (clampable state).

The large-diameter restricting/engaging portion 553B is provided on the eject-restricting window 553 adjacent to the rear face 10D and the left wall 10B. Specifically, the large-diameter restricting/engaging portion 553B is provided on a distal end of a large-diameter-corresponding groove 553E that extends from right side of the small-diameter restricting/engaging portion 553A toward the rear face 10D. The eject pin 611 is engaged with the large-diameter restricting/engaging portion 553B when a large-diameter disc 1A is ready to be held by the turntable 23 (clampable state).

The small-diameter spacing/engaging portion 553C is provided on the right-wall-10C side of the small-diameter restricting/engaging portion 553A slightly near the rear face 10D. The eject pin 611 is engaged with the small-diameter spacing/engaging portion 553C when a small-diameter disc 1B is held by the turntable 23 and ready to be information-processed by the information processor 24 (processable state).

The large-diameter spacing/engaging portion 553D is provided on the right-wall-10C side of the large-diameter restricting/engaging portion 553B slightly near the rear face 10D. The eject pin 611 is engaged with the large-diameter spacing/engaging portion 553D when the small-diameter disc 1B is held by the turntable 23 and ready to be information-processed by the information processor 24 (processable state).

The select pin 554 protrudes from the link plate 55 near the rear face 10D and the right wall 10C toward a below-described first shift cam 71 of the disc clamper 70 The cam control pin 555 protrudes from the link plate 55 adjacent to the front face 10A and the right wall 10C toward the first shift cam 71 of the disc clamper 70 in the same manner as the select pin 554.

Switch pieces 550, 556 that are bent toward the bottom face of the casing 10 are provided on a periphery of the link plate 55 near the rear face 10D. The switch pieces 550, 556 switch a first switch SW1 and a second switch SW2 provided on the control circuit 80 disposed on the bottom face of the casing 10 in accordance with right and left movement of the link plate 55.

The first switch SW1 and the second switch SW2 are provided on the control circuit 80 near the rear face 10D on the course of the right and left movement of the switch pieces 550, 556. The first switch SW1 is provided near the left wall 10B adjacent to the connector section 15. The second switch SW2 is provided on the side of the right wall 10C relative to the first switch SW1.

Specifically, the first switch SW1 is provided at a position capable of detecting that a first longitudinal end of the loading arm 51 is rotated to retract from the transfer course extending in the front-and-back direction as predetermined. On the other hand, the second switch SW2 is provided at a position capable of detecting that the first longitudinal end of the loading arm 51 is rotated from a location within the transfer course, i.e., detecting whether the loading arm 51 is rotated by the optical disc 1 from the stand-by position.

The first switch SW1 and the second switch SW2 each include a switch body and a movable piece that protrudes from the switch body toward the rear face 10D and is capable of advancement and retraction relative to the switch body. The first switch SW1 and the second switch SW2 are at OFF state when the movable piece is protruded. The OFF state is detected by the control circuit 80 as “H (High)” level based on a reference voltage supplied by the control circuit 80. On the other hand, when the switch pieces 550, 556 are in contact with the movable pieces, the movable pieces are moved toward the inside of the switch bodies to be ON state, which is detected by the control circuit 80 as “L (Low)” level based on the reference voltage supplied by the control circuit 80.

Both of the first switch SW1 and the second switch SW2 are set as the OFF state with the movable piece being protruded toward the rear face 10D at an initial state where the optical disc 1 is not inserted. When the optical disc 1 is inserted and the link plate 55 is moved toward the left wall 10B in accordance with the rotation of the loading arm 51 and the disc guide arm 53, the second switch SW2 is immediately turned into ON state (L level). Subsequently, when the link plate 55 is moved further toward the left side, the first switch SW1 is turned into ON state (L level).

Next, the arrangement of the unloading unit 60 will be described below. As shown in FIGS. 1 and 3, the unloading unit 60 includes a first eject arm 61 and a second eject arm 62. The first eject arm and the second eject arm 62 are intersected in a rotatable manner near the rear face 10D of the casing 10. Specifically, the first eject arm 61 longitudinally extends from the right rear side toward the left front side. The second eject arm 62 longitudinally extends from the left rear side toward the right front side. Rotary center shafts 61A, 62A of the first and the second eject arms 61, 62 are respectively spaced from the rear face 10D toward the front face 10A by a predetermined distance, the rotary center shafts 61A, 62A being respectively disposed between a centerline L passing through the center of the turntable 23 and the right wall 10C and between the centerline L and the left wall 10B. At this time, the rotary center shafts 61A and 62A are mutually symmetrical relative to the centerline L. According to the above arrangement, the rotary center shafts 61A, 62A can be attached to positions without interfering with the first shift cam 71 and the connector section 15, so that the distal ends of the first and the second eject arms 61, 62 can be rotated close to the rear face 10D when a large-diameter disc 1A is inserted.

The first eject arm 61 includes the eject pin 611 protruding downward as described above. The eject pin 611 is engaged with the arm link groove 621 provided on the second eject arm 62, the eject-restricting window 553 of the link plate 55, and an eject arm restricting groove 171 provided on the top plate 17 disposed on the top side of the link plate 55. The eject pin 611 is rotated along the eject arm restricting groove 171, which is engaged on the way of the rotation with the small-diameter restricting/engaging portion 553A, the large-diameter restricting/engaging portion 553B, the small-diameter spacing/engaging portion 553C and the large-diameter spacing/engaging portion 553D of the eject-restricting window 553 to restrict the movement thereof. The movement of the eject pin 611 along the arm link groove 621 pushes the second eject arm 62, so that the second eject arm 62 is rotated in conjunction with the first eject arm 61.

Further, a first disc abutment portion 612 for contacting the optical disc 1 is provided on the distal end of the first eject arm 61 adjacent the left wall 10B. A cam pushing pin 613 (pushing member) that protrudes toward the first shift cam 71 is provided on the right base end of the first eject arm 61. When the first eject arm 61 is rotated, the cam pushing pin 613 pushes and moves the first shift cam 71 toward the front face 10A in accordance with the rotation of the first eject arm 61.

A spring-engaging-projection 614 is provided in the vicinity of the rotary center shaft 61A of the first eject arm 61. A spring is attached between the spring-engaging-projection 614 and a spring-engaging portion (not shown) of the second eject arm 62, so that the first eject arm 61 is constantly biased anticlockwise, i.e. in a direction for the first disc abutment portion 612 to be rotated toward the front face 10A.

Further, a third switch SW3 electrically connected to the control circuit 80 is provided on a movement path of the eject pin 611, specifically, at a position corresponding to an end of the eject arm restricting groove 171 near the rear face 10D. The third switch SW3 detects a holding state of the optical disc 1 (1A, 1B) of the transfer unit 30, which varies when the optical disc 1 (1A, 1B) with different diameters are loaded. Specifically, the third switch SW3 detects a rotation of the first eject arm 61 (i.e. advancement into the transfer course) that holds the optical disc 1 (1A, 1B) with different diameters relative to the transfer course.

Similarly to the first and the second switches SW1, SW2, the third switch SW3 includes a switch body and a movable piece protruding from the switch body, where the movable piece protrudes to the right side of the eject arm restricting groove 171. When the first eject arm 61 is rotated and the eject pin 611 moves toward the rear-face-10D side end of the eject arm restricting groove 171, the movable piece is pushed in to turn the third switch SW3 into ON state (L level). Accordingly, the control circuit 80 recognizes switching of the third switch SW3 between the ON/OFF states (L/H levels) to recognize the detecting state of the third switch SW3.

As described above, the second eject arm 62 is provided, substantially at the longitudinal center thereof with the arm link groove 621 that is curved substantially in an arc shape. When the eject pin 611 moves within the arm link groove 621, the periphery of the arm link groove 621 is pushed by the eject pin 611 to rotate the second eject arm 62.

A second disc abutment portion 622 for contacting the optical disc 1 is provided at the distal end of the second eject arm 62. The second disc abutment portion 622 is located constantly at a position substantially symmetrical with the first disc abutment portion 612 relative to the centerline L. In other words, when the first and the second eject arms 61, 62 are rotated, the first disc abutment portion 612 and the second disc abutment portion 622 are rotated in a manner constantly substantially axisymmetric relative to the centerline L. The first disc abutment portion 612 and the second disc abutment portion 622 of the first and the second eject arms 61, 62, the roller 513 of the loading arm 51 and the disc guide 532 of the disc guide arm 53 hold the periphery of the optical disc 1 (1A, 1B) to transfer the optical disc 1.

Next, the arrangement of the disc clamper 70 will be described below. As shown in FIGS. 1 and 3, the disc clamper 70 includes the first shift cam 71 (swing unit) and a second shift cam (swing unit) (not shown) provided on the rear-face-10D side of the disc processor 20.

The first shift cam 71 longitudinally extends in front-and-back direction along the stepped wall 13 of the casing 10. The first shift cam 71 is located the closest to the rear face 10D in an initial state, which is pushed toward the front face 10A by the cam pushing pin 613 of the first eject arm 61 as described above.

A rack 711 is provided on a left end surface of the first shift cam 71 adjacent to the front face 10A. The rack 711 is engageable with the pinion gear 425B of the cam shift gear 425. When the first shift cam 71 is pushed by the cam pushing pin 613 toward the front face 10A, the rack 711 is engaged with the pinion gear 425B, so that the first shift cam 71 is capable of advancement and retraction in front-and-back direction by the drive force from the drive unit 40.

A gap of greater thickness than that of the large-diameter shift gear 425A and the shift drive branch gear 422 is provided between the bottom face of the casing body 11 and the front-face-10A side of the first shift cam 71. Further, the top side of the first shift cam 71 is provided at a position closer to the bottom face of the casing body 11 than the top-side periphery of the stepped wall 13. With this arrangement, when the first shift cam 71 is moved toward the front face 10A, the front side end of the first shift cam 71 moves in the space above the large-diameter shift gear 425A and the shift drive branch gear 422 and the space below the roller drive branch gear 423 and the second transmission gear 424, thereby preventing the interference with the large-diameter shift gear 425A, the shift drive branch gear 422, the roller drive branch gear 423 and the second transmission gear 424.

Further, a cam groove 712 opposed to the top face is provided on the rear-face-10D side of the first shift cam 71. The cam groove 712 includes a standby groove 712A, an 8 cm-disc cam groove 712B, a 12 cm-disc cam groove 712C and a clamp groove 712D. The standby groove 712A is a groove provided on the front-face-10A side of the cam groove 712, which is longitudinal in right-and-left direction. The 8 cm-disc cam groove 712B is a groove continuous with the standby groove 712A to extend from the right-wall-10C side of the standby groove 712A toward the rear face 10D. The 12 cm-disc cam groove 712C is a groove continuous with the standby groove 712A to extend from the left-wall-10B side of the standby groove 712A toward the rear face 10D side. The clamp groove 712D is a groove continuous with the 8 cm-disc cam groove 712B and the 12 cm-disc cam groove 712C to extend along the left-wall-10B side of the first shift cam 71 toward the rear-face. The cam control pin 555 of the link plate 55 is inserted into the cam groove 712.

A first pushing wall 713 that rises toward the top plate is provided on the left-wall-10B side of the first shift cam 71 near the rear face 10D. As described above, the first pushing wall 713 is capable of contacting the cam pushing pin 613 of the first eject arm 61. When a large-diameter disc 1A is inserted, the first pushing wall 713 is pushed toward the front face 10A by the cam pushing pin 613.

The select arm 73 is rotatably attached to the first pushing wall 713 near the right wall 10C. The select arm 73 includes a pushing piece 732 extending toward the rear face 10D and a plate engaging piece 733 that extends toward the front face 10A. The pushing piece 732 and the plate engaging piece 733 are provided around a rotary shaft 731. A spring mount 734 is provided on a rear-face side of the select arm 73. A spring is provided between the spring mount 734 and the spring mount 714 provided on the first shift cam 71, so that the select arm 73 is constantly biased clockwise.

The pushing piece 732 is provided with a second pushing wall 735 on an end near the rear face 10D. In the same manner as the first pushing wall 713, the cam pushing pin 613 is capable of contacting the second pushing wall 735, which is pushed toward the front face 10A when a small-diameter disc 1B is inserted.

The distal end of the plate engaging piece 733 is curved toward the left wall 10B to provide a pin engaging portion 733A adapted to be engaged with the select pin 554 of the link plate 55 (see FIG. 3). When the link plate 55 is located near the right wall 10C (initial state), the select pin 554 is engaged with the pin engaging portion 733A of the plate engaging piece 733 to restrict the rotation of the select arm 73. On the other hand, when a large-diameter disc 1A is inserted and the link plate 55 is shifted toward the left wall 10B, the select pin 554 is disengaged from the pin engaging portion 733A to allow clockwise rotation of the select arm 73. Accordingly, the cam pushing pin 613 of the first eject arm 61 is capable of contacting the first pushing wall 713.

As shown in FIG. 4, a clamper elevating groove 715 is provided on the first shift cam 71 near the left wall 10B. A clamper elevating pin 21C projecting from the base 21 toward the right wall 10C is engaged with the clamper elevating groove 715, where the clamper elevating pin 21C is moved to elevate the base 21 in accordance with the advancement and the retraction of the first shift cam 71. The total movement stroke of the first shift cam 71 in the front-and-rear direction can be used for the control of the pivotal movement of the disc processor 20, i.e. the elevation of the clamper. Accordingly, the range capable of providing the clamper elevating groove 715 can be widened. The clamper elevating groove 715 includes an escape section 715A, a standby section 715B, a clamp section 715C and an in-process section 715D, which are consecutively provided.

The escape section 715A is provided on the clamper elevating groove 715 adjacent to the front face 10A. The escape section 715A extends in front-and-back direction at a height position nearest to the bottom face of the casing 10. When the clamper elevating pin 21C is engaged with the escape section 715A, the disc processor 20 is swung toward the bottom face of the casing 10 so that the turntable 23 is escaped from the transfer course (escape state).

The standby section 715B is formed continuously from the escape section 715A closer to the rear face 10D than the escape section 715A. The standby section 715B is linearly shaped substantially along front-back direction. When the clamper elevating pin 21C is engaged with the standby section 715B, the optical disc 1 mounted on the turntable 23 is maintained at a position apart from an opposing surface of the casing 10 until the disc processor 20 is swung from the escape state to clamp the optical disc 1 (clamp state). Thus, the position adjustment between the centerhole of the optical disc 1 and the turntable 23 is made possible in the standby state.

In addition, the standby section 715B is disposed at substantially the same height position as the in-process section 715D. With this arrangement, the swing position of the disc processor 20 in the standby state is substantially the same swing position as the swing position of the disc processor 20 in a processable state. The procesasble state is a state in which the information processor 24 can conduct an information processing on the optical disc 1. Incidentally, the swing position is equivalent to an amount by which the disc processor 20 is pivotally swung about the floating rubber 21A from the reference position. The reference position is the position at which the disc processor 20 is located in the standby state.

The clamp section 715C is formed continuously from the standby section 715B, closer to the rear face 10D than the standby section 715B, as a mountain-like groove projecting toward the top face relative to the standby section 715B and the in-process section 715D. When the clamper elevating pin 21C is engaged with the clamp section 715C, the disc processor 20 is swung toward the top face of the casing 10 so that the optical disc is clamped to the turntable 23 (clamp state). More specifically, in the clamp state, the disc processor 20 is moved toward the top face so that the turntable 23 is abutted or approached to a clamp member (not shown). At this time, the optical disc 1 held by the loading arm 51, the disc guide arm 53, the first eject arm 61 and the second eject arm 62 is pushed to the turntable 23. Accordingly, the optical disc 1 is sandwiched between the clamp member and the turntable 23, and the centerhole of the optical disc 1 is engaged with the disc engaging portion 23A of the turntable 23. Further, the claw members are engaged with the centerhole to chuck the optical disc 1 onto the turntable 23.

The in-process section 715D is formed continuously from the clamp section 715C, closer to the rear face 10D than the clamp section 715C. The in-process section 715D resides substantially at the same height position as the standby section 715B as set forth above, and is linearly shaped substantially along front-back direction. When the clamper elevating pin 21C is engaged with the in-process section 715D, the disc processor 20 is swung toward the bottom face of the casing 10 so that the information processor 24 can conduct information processing on the optical disc 1 (in-process state). In the in-process state, the turntable 23 is substantially parallel to the bottom face and the top face of the casing 10, so that the optical disc 1 chucked to the turntable 23 is property rotatable without being abutted to the inner face of the casing 10.

A fourth switch SW4 mounted on the control circuit 80 disposed on, for instance, the bottom face is provided near a rear portion of the first shift cam 71. The fourth switch SW4 detects the pivotal movement of the disc processor 20. Specifically, the fourth switch SW4 detects the moving condition of the first shift cam 71 for pivotally moving the disc processor 20 to detect the pivotal movement of the disc processor 20.

Similarly to the switches SW1, SW2 and SW3, the fourth switch SW4 is connected to the control circuit 80, which includes a switch body and a movable piece. In initial state, the movable piece is pushed by the left end surface of the first shift cam 71. When the first shift cam 71 is moved toward the front face 10A, the movable piece of the fourth switch SW4 protrudes to establish OFF state (H level). As described, the control circuit 80 recognizes switching of the fourth switch SW4 between the ON/OFF states (L/H levels) to recognize the detecting state of the fourth switch SW4.

The second shift cam slides in right-and-left direction in conjunction with the movement of the first shift cam 71. Specifically, when the first shift cam 71 is moved toward the front face 10A, the second shift cam is moved toward the left wall 10B. When the first shift cam 71 is moved toward the rear face 10D, the second shift cam moves toward the right wall 10C. A clamper elevating groove (not shown) having the same shape as the camper elevating groove 715 of the first shift cam 71 is provided on the front end surface of the second shift cam. A clamper elevating pin 21C (not shown) protruding from the base 21 toward the rear face 10D is engaged into the clamper elevating groove. The second shift cam moves in the right-and-left direction to pivotally move the disc processor 20 in the same manner as the first shift cam 71.

Operation of Disc Device

Next, an operation of the disc device will be described below with reference to drawings.

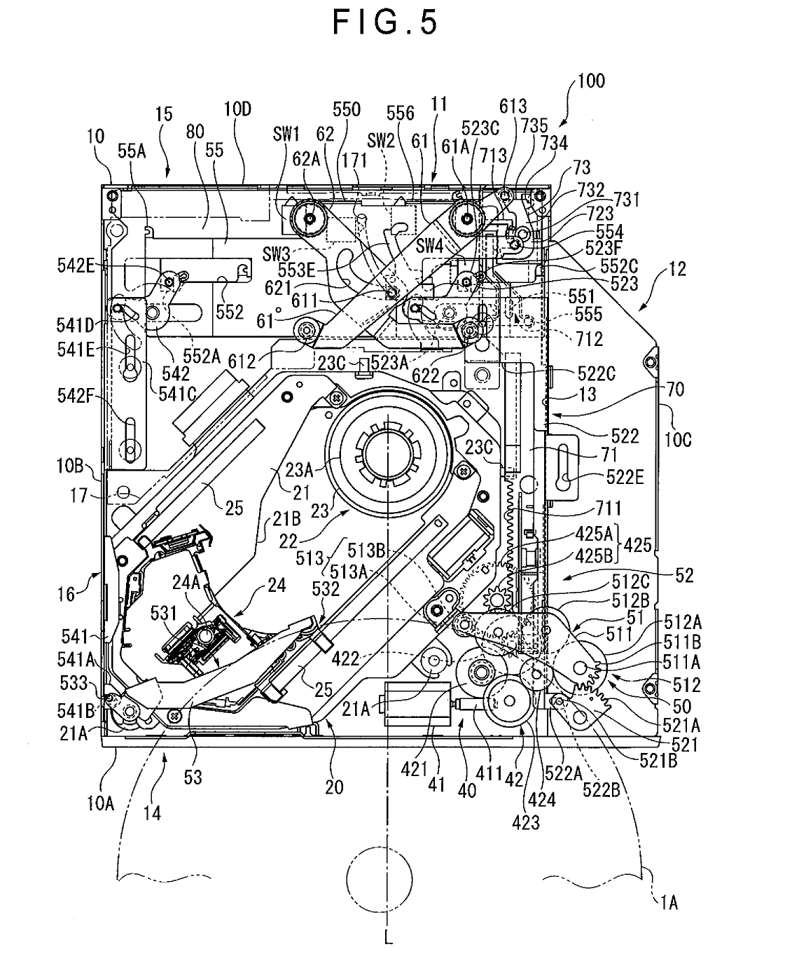

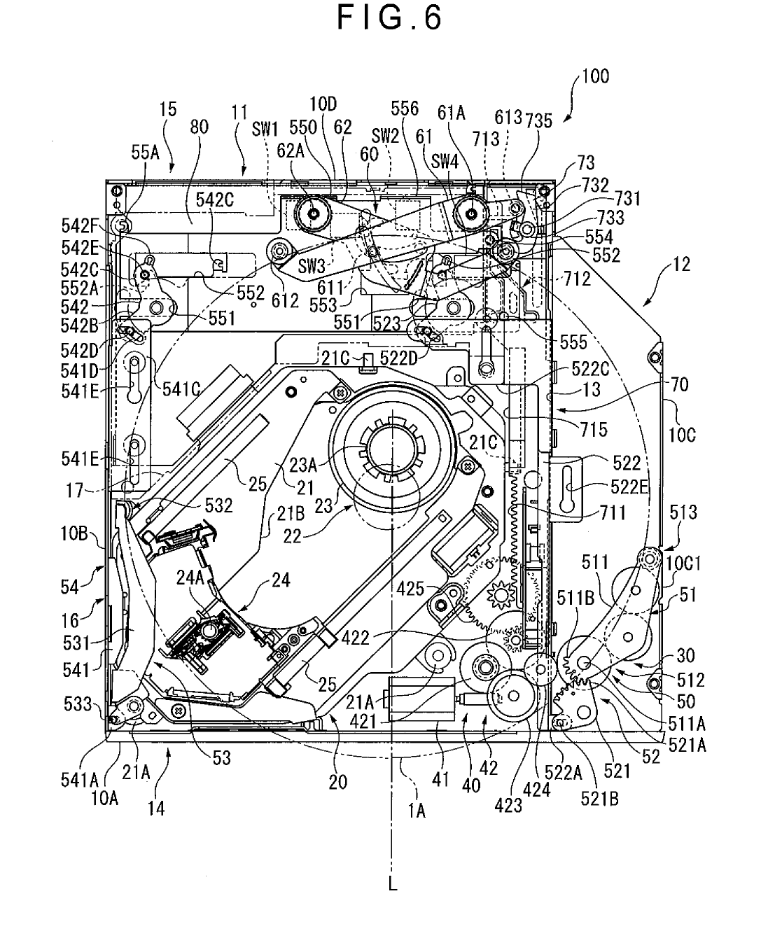

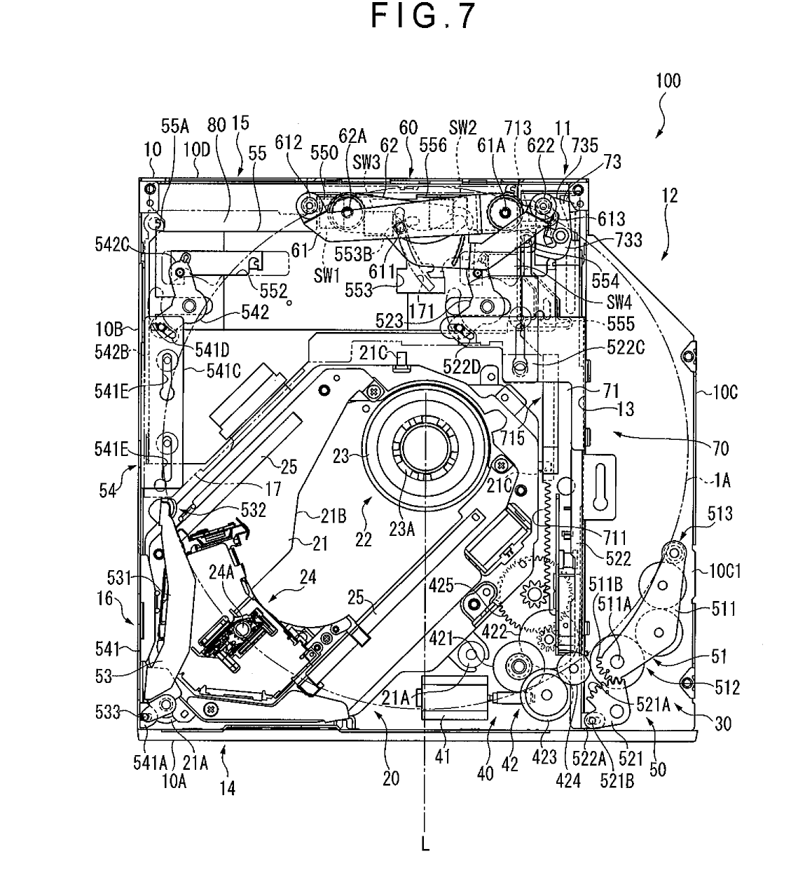

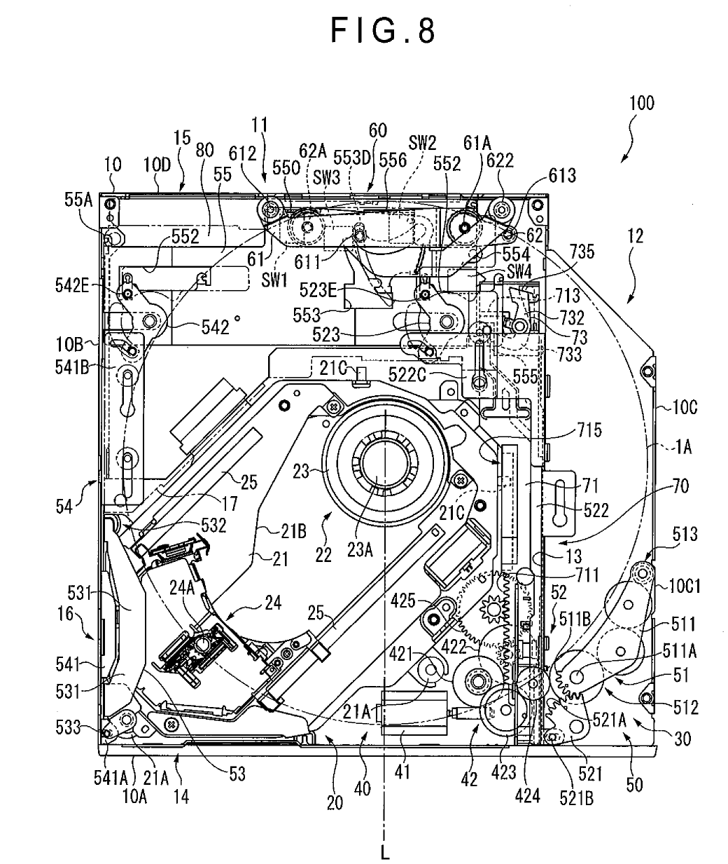

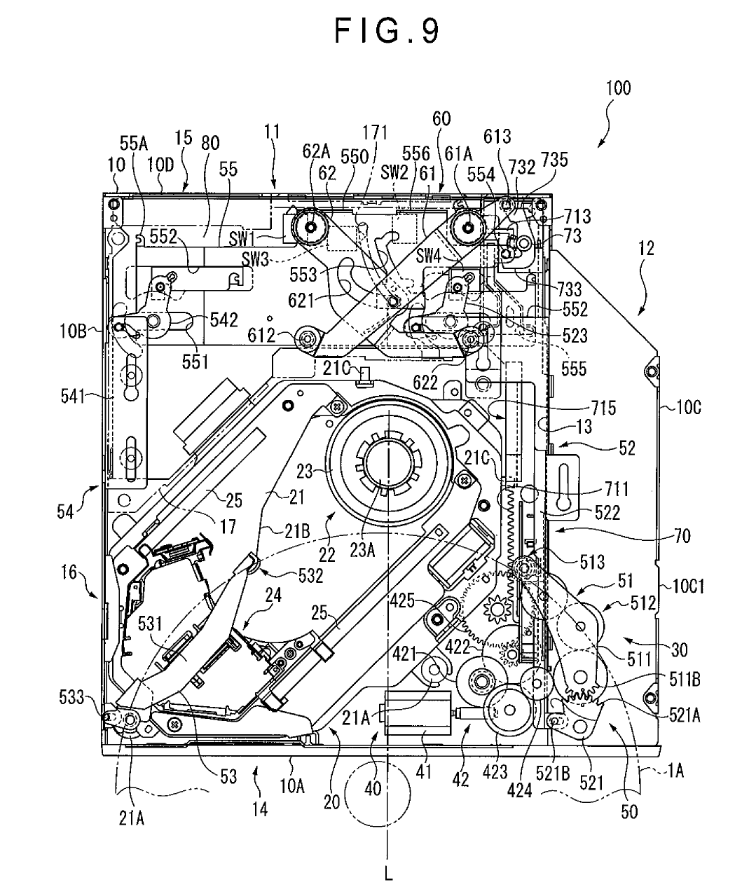

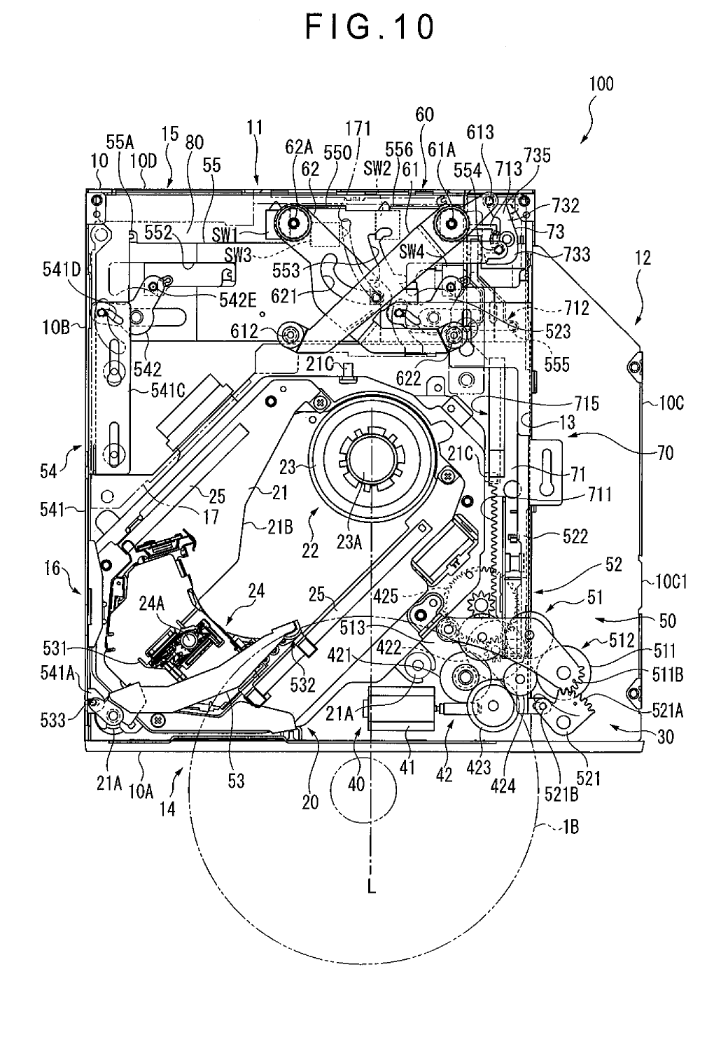

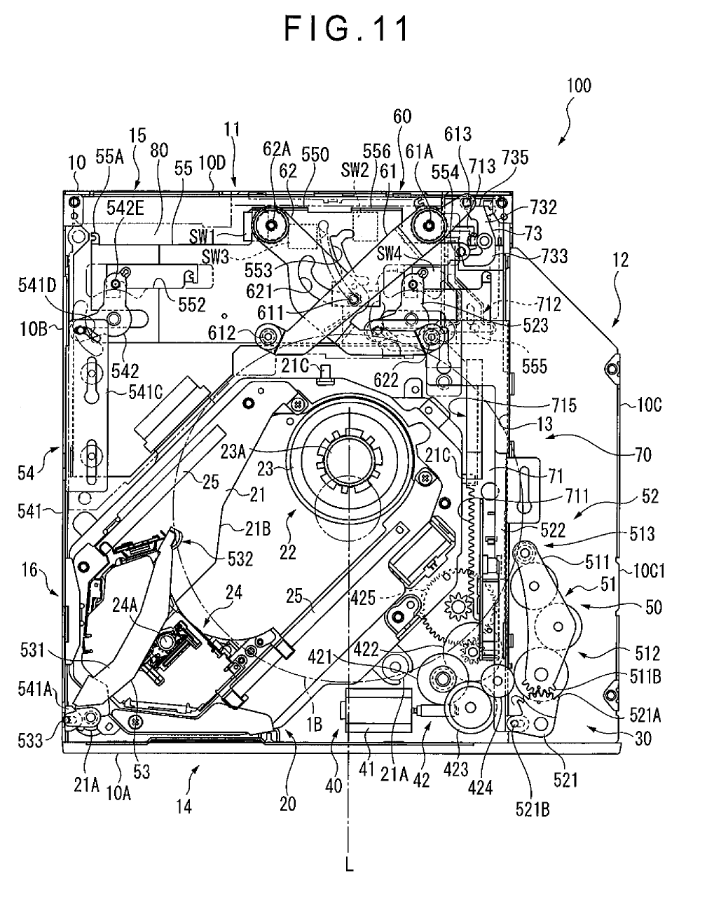

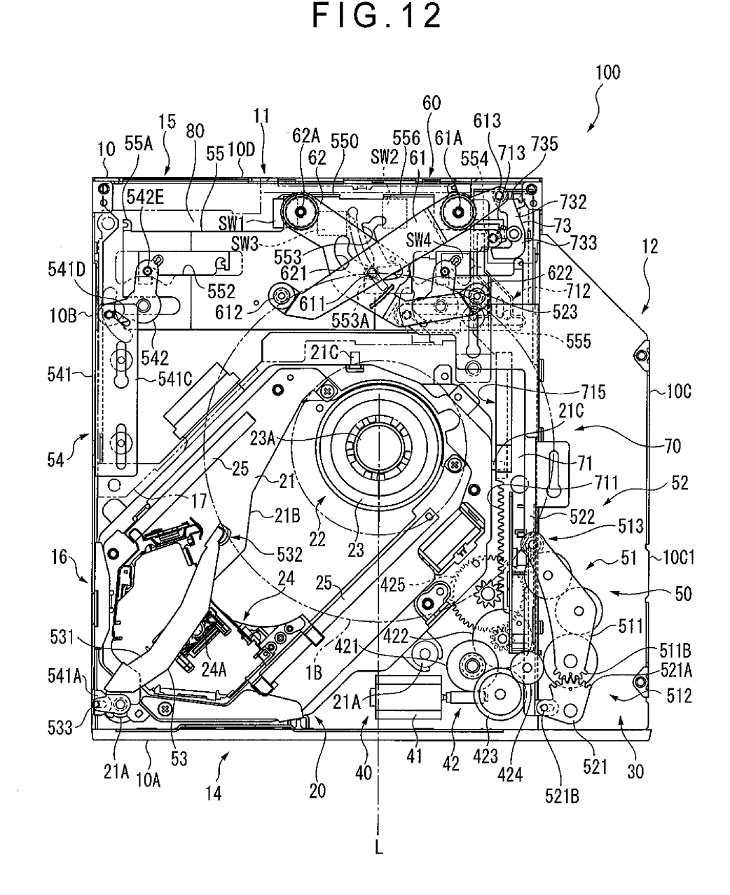

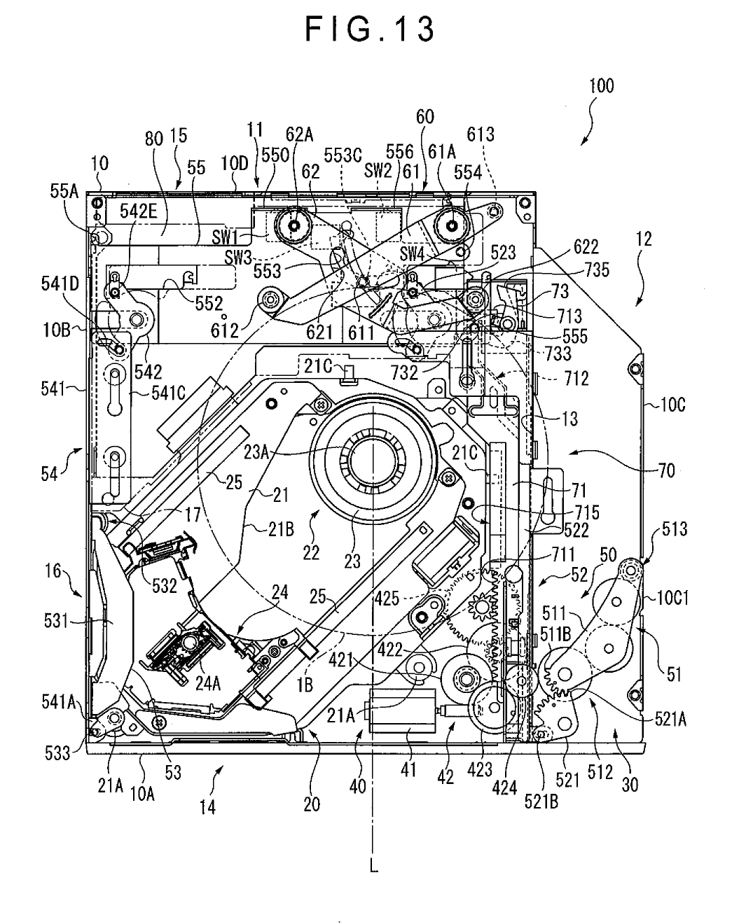

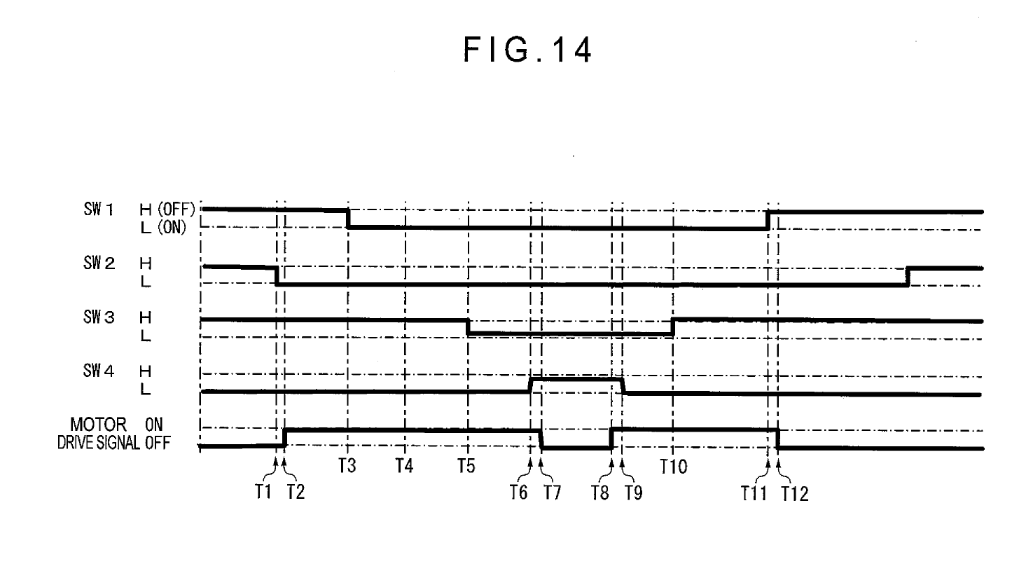

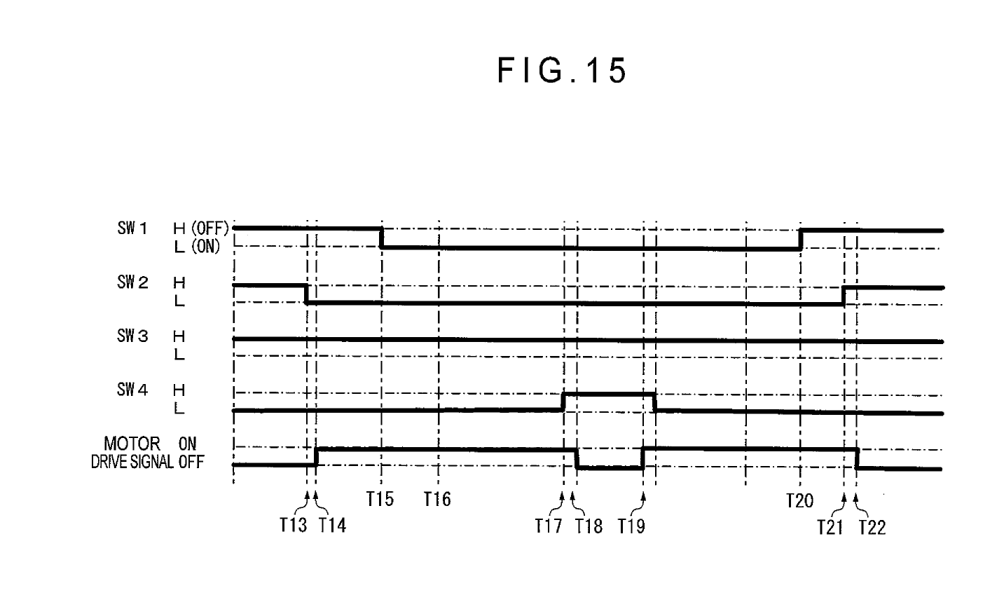

FIG. 5 is a top view showing the inside of the disc device when a large-diameter disc is to be inserted. FIG. 6 is a top view showing the inside of the disc device while the large-diameter disc is being transferred. FIG. 7 is a top view showing the inside of the disc device when the large-diameter disc is completely loaded. FIG. 8 is a top view showing the inside of the disc device when the large-diameter disc has been clamped. FIG. 9 is a top view showing the inside of the disc device when the large-diameter disc has been unloaded. FIG. 10 is a top view showing the inside of the disc device when a small-diameter disc is to be loaded and when the small-diameter disc has been unloaded. FIG. 11 is a top view showing the inside of the disc device while the small-diameter disc is being transferred. FIG. 12 is a top view showing the inside of the disc device when the small-diameter disc has been loaded. FIG. 13 is a top view showing the inside of the disc device when the small-diameter disc has been clamped. FIG. 14 is a timing chart of a first to fourth switches in accordance with progress in transfer of the large-diameter disc. FIG. 15 is a timing chart of a first to fourth switches in accordance with progress in transfer of the small-diameter disc.

Loading of Large-Diameter Disc

Initially, loading operation(s) when a large-diameter disc 1A is inserted into the disc device 100 will be described below.

As shown in FIG. 5, when a large-diameter disc 1A is inserted through the insertion-and-ejection opening 14 of the disc device 100 during the initial state, a periphery of the large-diameter disc 1A is brought into contact with the roller 513 of the loading arm 51 and the disc guide 532 of the disc guide arm 53. In this state, when the large-diameter disc 1A is further inserted toward the rear face 10D, the loading arm 51 is rotated toward the right wall 10C and the disc guide arm 53 is rotated toward the left wall 10B. With this operation, the link plate 55 is also slid toward the left wall 10B in conjunction with the rotation of the loading arm 51 and the disc guide arm 53.

When the switch piece 556 of the link plate 55 is brought into contact with the movable piece of the second switch SW2 to turn the second switch SW2 into ON state (L level) (T1 in FIG. 14), the control circuit 80 of the disc device 100 controllably drives the drive motor 41 of the drive unit 40. Then, the drive force of the drive motor 41 is transmitted to the roller 513 of the loading arm 51, so that the roller 513 is rotated in a direction for the large-diameter disc 1A to be loaded into the inside of the casing 10 (T12 in FIG. 14).

Further, the loading arm 51 and the disc guide arm 53 guide the transfer of the large-diameter disc 1A with the roller 513 and the disc guide 532 while the center of the centerhole of the large-diameter disc 1A is slightly shifted leftward relative to the centerline L. While the roller 513 and the disc guide 532 hold the largest-diameter section of the large-diameter disc 1A, the loading arm 51 and the disc guide arm 53 are respectively rotated nearest to the right wall 10C and the left wall 10B. At this time, the right-wall-10C side of the roller 513 is inserted into the escape hole provided on the right wall 10C to avoid interference between the roller 513 and the right wall 10C.

Subsequently, when the large-diameter disc 1A is further loaded into the casing 10 manually or by the drive force of the roller 513, the insertion tip end of the large-diameter disc 1A is in contact with the first disc abutment portion 612 of the first eject arm 61. Then, when the large-diameter disc 1A is further transferred toward the rear face 10D by the roller 513, the first eject arm 61 is rotated. At this time, the large-diameter disc 1A is transferred while being held between the first disc abutment portion 612 of the first eject arm 61 and the second disc abutment portion 622 of the second eject arm 62, so that the center of the centerhole of the large-diameter disc 1A is moved on the centerline L of the disc device 100.

When the large-diameter disc 1A is further moved toward the rear face 10D, the link plate 55 is further moved toward the left wall 10B. With this operation, as shown in FIG. 6, the switch piece 550 is in contact with the movable piece of the first switch SW1 to turn the first switch SW1 into ON state (L level) (T3 in FIG. 14).

Subsequently, when the large-diameter disc 1A is further inserted, the eject pin 611 is engaged with the large-diameter restricting/engaging portion 553B to restrict the movement of the first eject arm 61. Further, when the large-diameter disc 1A is inserted, since the loading arm 51 and the disc guide arm 53 are respectively rotated toward the right wall 10C and the left wall 10B, the link plate 55 is also greatly moved toward the left wall 10B. Accordingly, the select pin 554 of the link plate 55 is disengaged from the pin engaging portion 733A of the select arm 73 to allow the clockwise rotation of the select arm 73. Accordingly, the cam pushing pin 613 of the first eject arm 61 is not in contact with the second pushing wall 735 of the select arm 73 but is rotated to contact with the first pushing wall 713. Further, the cam control pin 555 is moved to the interconnection between the standby groove 712A and the 12 cm-disc cam groove 712C of the cam groove 712 in accordance with the movement of the link plate 55.

Then, when the large-diameter disc 1A is completely loaded and is moved above the turntable 23 as shown in FIG. 7 (T4 in FIG. 14), the cam pushing pin 613 pushes the first pushing wall 713 toward the front face 10A. With this operation, the first shift cam 71 is moved toward the front face 10A to engage the rack 711 and the pinion gear 425B of the cam shift gear 425. Then, the first shift cam 71 is moved toward the front face 10A by the drive force transmitted by the drive unit 40 to start clamping operation.

The clamping operation is effected by moving the clamper elevating pin 21C of the base 21 within the clamper elevating groove 715 in the first shift cam 71 in accordance with the movement of the first shift cam 71. Specifically, when the first shift cam 71 is about to be moved, the clamper elevating pin 21C is located at the escape section 715A, where the base 21 is positioned near the bottom side of the casing 10 corresponding to the height position of the escape section 715A (escape state).

When the first shift cam 71 is moved toward the front face 10A from this escape state, the clamper elevating pin 21C is moved toward the standby section 715B. Accordingly, the elevation of the base 21 is stopped at the height position corresponding to the standby section 715B (standby state), where the position adjustment between the centerhole of the optical disc 1 and the disc engaging portion 23A of the turntable 23 is conducted.

When the first shift cam 71 is further moved toward the front face 10A, the clamper elevating pin 21C is moved to the clamp section 715C. With this operation, the base 21 is moved toward the top face to hold the large-diameter disc 1A between the turntable 23 and the clamp member provided on the top face and engage the disc engaging portion 23A with the centerhole of the large-diameter disc 1A to finish the clamping operation (clamp state). Subsequently, when the clamper elevating pin 21C is moved to the in-process section 715D, the base 21 is moved to a height position capable of processing the information on the large-diameter disc 1A by the information processor 24 as shown in FIG. 8 (processable state).

Incidentally, although in the embodiment the first shift cam 71 is moved only toward the front face 10A to perform the clamp operation only once, a so-called double clamp operation in which the clamp operation is conducted twice may also be conducted. Specifically, the first shift cam 71 is moved toward the front face 10A to swing the disc processor 20 into the escape state, the standby state, and the clamp state, thereby performing the first clamp operation. Then, the drive unit 40 is reversely rotated to move the first shift cam 71 in an opposite direction, which swings the disc processor 20 temporarily into the standby state. In this case, simply by moving the first shift cam 71 in the opposite direction till the disc processor 20 is set to the standby state, the optical disc 1 is prepared to undergo a position adjustment conducted by a slight rotation of the turntable 23. Subsequently, the drive unit 40 is normally rotated again to move the first shift cam 71 toward the front face 10A. The movement of the first shift cam 71 swings the disc processor 20 via the clamp state into the processable state. The second clamp operation is thus conducted.

During the clamping operation, the cam control pin 555 moves through the 12 cm-disc cam groove 712C to the clamp groove 712D. Accordingly, the link plate 55 is further moved toward the left wall 10B and the eject pin 611 is moved from the large-diameter restricting/engaging portion 553B toward the large-diameter spacing/engaging portion 553D. Specifically, the first and the second eject arms 61, 62 are rotated toward the rear face 10D so that the first and the second disc abutment portions 612, 622 are spaced apart from the periphery of the large-diameter disc 1A. At this time, the eject pin 611 turns the third switch SW3 provided on the bottom side of the eject arm restricting groove 171 into ON state (L level) (T5 in FIG. 14).

The loading arm 51 and the disc guide arm 53 are respectively rotated near to the right wall 10C and the left wall 10B in accordance with the movement of the link plate 55, so that the roller 513 and the disc guide 532 are spaced apart from the periphery of the large-diameter disc 1A.

Subsequently, when the first shift cam 71 is further moved toward the front face 10A, the movable piece of the fourth switch SW4 and the end surface of the first shift cam 71 are spaced to turn the fourth switch into OFF state (H level) (T6 in FIG. 14). With the operation, the control circuit 80 recognizes the completion of the clamping operation of the large-diameter disc 1A to stop the drive motor 41 (T7 in FIG. 14). At this time, the control circuit 80 determines the diameter of the optical disc 1 based on the condition of the third switch SW3 and the fourth switch SW4. Specifically, if the third switch SW3 is ON state (L level) when the fourth switch SW4 is turned into OFF state (H level), the control circuit 80 judges that the inserted optical disc 1 is the large-diameter disc 1A. In contrast, as described later in detail, if the third switch SW3 is OFF state (H level) when the fourth switch SW4 is turned into OFF state (H level), the control circuit 80 judges that the inserted optical disc 1 is a small-diameter disc 1B.

Then, the control circuit 80 controls the drive of the information processor 24 of the disc processor 20, so that writing processing for writing information onto the large-diameter disc 1A and reading processing for reading the information stored in the large-diameter disc 1A are conducted.

Unloading of Large-Diameter Disc

Next, operation(s) of unloading a large-diameter disc 1A will be described.

When the control circuit 80 of the disc device 100 recognizes an input signal for unloading the large-diameter disc 1A inputted by pushing an eject button (not shown) and the like, the control circuit 80 conducts operation(s) for unloading the large-diameter disc 1A to the outside of the casing 10. Specifically, the control circuit 80 initially controls the drive motor 41 to be driven.

During the unloading operation, the control circuit 80 initially drives the drive motor 41 of the drive unit 40 (T8 in FIG. 14) to move the first shift cam 71 toward the rear face 10D. The fourth switch SW4 is turned into ON state (L level) in accordance with the movement of the first shift cam 71 toward the rear face 10D (T9 in FIG. 14).

Further, the cam control pin 555 moves within the cam groove 712 in accordance with the movement of the first shift cam 71 toward the rear face 10D to move the link plate 55 toward the right wall 10C. Accordingly, the loading arm 51, the disc guide arm 53 and the first and the second eject arms 61, 62 are rotated in conjunction with the link plate 55, so that the optical disc 1 is held by the roller 513, the disc guide 532 and the first and the second disc abutment portions 612, 622. At this state, the third switch SW3 is turned into OFF state (H level) (T10 in FIG. 14).

When the first shift cam 71 is further moved toward the rear face 10D in this state, since the base 21 is moved toward the bottom side, the large-diameter disc 1A is disengaged from the turntable 23.

Subsequently, the large-diameter disc 1A is transferred toward the front face 10A by virtue of the drive of the roller 513 of the loading arm 51 and the biasing force of the first and the second eject arms 61, 62 to be ejected from the insertion-and-ejection opening 14. Further, when the link plate 55 is moved toward the right wall 10C to turn the first switch SW1 into OFF state (H level) (T11 in FIG. 14), the control circuit 80 stops the drive motor 41 (T12 in FIG. 14) to stop driving the roller 513.

Loading of Small-Diameter Disc

Next, loading operation(s) when a small-diameter disc 1B is inserted into the disc device 100 will be described below. As shown in FIG. 9, when the small-diameter disc 1B is inserted through the insertion-and-ejection opening 14 of the disc device 100 during the initial state, a periphery of the small-diameter disc 1B is brought into contact with the roller 513 of the loading arm 51 and the disc guide 532 of the disc guide arm 53. In this state, when the small-diameter disc 1B is further inserted toward the rear face 10D, the loading arm 51 is rotated toward the right wall 10C and the disc guide arm 53 is rotated toward the left wall 10B. With this operation, the link plate 55 is also slid toward the left wall 10B in conjunction with the rotation of the loading arm 51 and the disc guide arm 53.

When the switch piece 556 of the link plate 55 is brought into contact with the movable piece of the second switch SW2 to turn the second switch SW2 into ON state (L level) (T13 in FIG. 15), the control circuit 80 of the disc device 100 controls drives the drive motor 41 of the drive unit 40 to be driven. Then, the drive force of the drive motor 41 is transmitted to the roller 513 of the loading arm 51, so that the roller 513 is rotated in a direction for the small-diameter disc 1B to be loaded into the inside of the casing 10 (T14 in FIG. 15).

Subsequently, when the small-diameter disc 1B is further loaded into the casing 10 manually or by the drive force of the roller 513, the insertion tip end of the small-diameter disc 1B is in contact with the first disc abutment portion 612 of the first eject arm 61. Then, when the small-diameter disc 1B is further transferred toward the rear face 10D by the roller 513, the first eject arm 61 is rotated. At this time, the small-diameter disc 1B is transferred while being held between the first disc abutment portion 612 of the first eject arm 61 and the second disc abutment portion 622 of the second eject arm 62, so that the center of the small-diameter disc 1B is moved on the centerline L of the disc device 100.

When the small-diameter disc 1B is further moved toward the rear face 10D, the link plate 55 is further moved toward the left wall 10B. Accordingly, as shown in FIG. 11, the switch piece 550 is in contact with the movable piece of the first switch SW1 to turn the first switch SW1 into ON state (L level) (T15 in FIG. 15).

Subsequently, when the small-diameter disc 1B is further inserted, the eject pin 611 is engaged with the small-diameter restricting/engaging portion 553A to restrict the movement of the first eject arm 61. Further, the cam pushing pin 613 of the first eject arm 61 is brought into contact with the second pushing wall 735 of the select arm 73. At this time, the cam control pin 555 is moved to the interconnection between the standby groove 712A and the 8 cm-disc cam groove 712B of the cam groove 712 in accordance with the movement of the link plate 55.

Then, when the small-diameter disc 1B is completely loaded and is moved above the turntable 23 as shown in FIG. 11 (T16 in FIG. 15), the cam pushing pin 613 pushes the second pushing wall 735 toward the front face 10A. With this operation, the first shift cam 71 is moved toward the front face 10A to engage the rack 711 and the pinion gear 425B of the cam shift gear 425. Then, the first shift cam 71 is moved toward the front face 10A by the drive force transmitted by the drive unit 40 to start clamping operation. Since the clamping operation(s) is the same as that of the large-diameter disc 1A, the description thereof is omitted herein.

During the clamping operation, the cam control pin 555 moves through the 8 cm-disc cam groove 712B to the clamp groove 712D. Accordingly, the link plate 55 is further moved toward the left wall 10B and the eject pin 611 is moved from the small-diameter restricting/engaging portion 553A toward the small-diameter spacing/engaging portion 553C. Specifically, the first and the second eject arms 61, 62 are rotated toward the rear face 10D so that the first and the second disc abutment portions 612, 622 are spaced apart from the periphery of the small-diameter disc 1B.

The loading arm 51 and the disc guide arm 53 are respectively rotated near to the right wall 10C and the left wall 10B in accordance with the movement of the link plate 55, so that the roller 513 and the disc guide 532 are spaced apart from the periphery of the small-diameter disc 1B.

Subsequently, when the first shift cam 71 is further moved toward the front face 10A, the movable piece of the fourth switch SW4 and the end surface of the first shift cam 71 are spaced to turn the fourth switch into OFF state (H level) (T17 in FIG. 15). Accordingly, the control circuit 80 recognizes the completion of the clamping operation to stop the drive motor 41 (T18 in FIG. 15). At this time, the control circuit 80 determines the diameter of the optical disc 1 based on the condition of the third switch SW3 and the fourth switch SW4 as described above. Specifically, if the third switch SW3 is OFF state (H level) when the fourth switch SW4 is turned into OFF state (H level), the control circuit 80 judges that the inserted optical disc 1 is the small-diameter disc 1B.

Then, the control circuit 80 controls the drive of the information processor 24 of the disc processor 20, so that writing processing for writing information onto the small-diameter disc 1B and reading processing for reading the information stored in the small-diameter disc 1B are conducted.

Unloading of Small-Diameter Disc

Next, operation(s) of unloading the small-diameter disc 1B will be described.

When the control circuit 80 of the disc device 100 recognizes an input signal for unloading the small-diameter disc 1B inputted by pushing an eject button (not shown) and the like, the control circuit 80 conducts operation(s) for unloading the small-diameter disc 1B to the outside of the casing 10. Specifically, the control circuit 80 initially controls the drive motor 41 to be driven.

During the unloading operation, in the same manner as the unloading operation of the large-diameter disc 1A, the control circuit 80 initially drives the drive motor 41 of the drive unit 40 (T19 in FIG. 15) to move the first shift cam 71 toward the rear face 10D. The fourth switch SW4 is turned into ON state (L level) in accordance with the movement of the first shift cam 71 toward the rear face 10D (T20 in FIG. 15).

Further, the cam control pin 555 moves within the cam groove 712 in accordance with the movement of the first shift cam 71 toward the rear face 10D to move the link plate 55 toward the right wall 10C. Accordingly, the loading arm 51, the disc guide arm 53 and the first and the second eject arms 61, 62 are rotated in conjunction with the link plate 55, so that the small-diameter disc 113 is held by the roller 513, the disc guide 532 and the first and the second disc abutment portions 612, 622. When the first shift cam 71 is further moved toward the rear face 10D in this state, since the base 21 is moved toward the bottom side, the small-diameter disc 1B is disengaged from the turntable 23.

Subsequently, the small-diameter disc 1B is transferred to the front face 10A by virtue of the drive of the roller 513 of the loading arm 51 and the biasing force of the first and the second eject arms 61, 62. Incidentally, though the first switch SW1 is turned into OFF state (H level) during the transfer of the small-diameter disc 1B toward the front face 10A (T21 in FIG. 15), since the control circuit 80 has determined that the loaded optical disc 1 is the small-diameter disc 1B during the above-described loading operation, the driving of the drive motor 41 is not stopped here.

Subsequently, when the small-diameter disc 1B is further transferred to the front face 10A, the small-diameter disc 1B is ejected through the insertion-and-ejection opening 14. When the second switch SW2 is turned into OFF state (H level) (T22 in FIG. 15), the control circuit 80 stops the drive motor 41 (T23 in FIG. 15) to stop driving the roller 513.

### EFFECT AND ADVANTAGE OF DISC DEVICE

As set forth above, the disc device 100 of the embodiment includes: the casing 10; the drive unit 40; the disc processor 20 including the turntable 23, the spindle motor, the information processor 24 and swingably supported to the interior of the casing 10; and the first shift cam 71 driven by the drive unit 40 to swing the disc processor 20. The first shift cam 71 restricts the swing of the disc processor 20 so that the disc processor 20 becomes each of the escape state, the clamp state, and the standby state. The escape state is a state in which the turntable 23 is escaped from the transfer course. The clamp state is a state in which the optical disc 1 is clamped to the turntable 23 while being abutted to the inner face of the casing 10 opposite to the turntable 23. The standby state is a state in which the optical disc 1 clamped to the turntable 23 is allowed to keep a position apart from the opposing face of the casing 10 while the disc processor 20 is swung from the escape state to the clamp state.

With this arrangement, during the swinging of the disc processor 20 from the standby state to the clamp state with the first shift cam 71 being moved by the driving of the drive unit 40, the disc processor 20 can be maintained at a position where the swinging of the disc processor 20 is retrained (i.e., standby state) irrespective of the movement of the first shift cam 71. Therefore, if the clamp operation is to be conducted twice (i.e. a so-called double clamp operation), the first shift cam 71 only needs to be moved in the reverse direction as necessary such that the disc processor 20 becomes the standby state. Note that in a double clamp operation: the drive of the drive unit 40 is reversed; the first shift cam 71 is moved in a reversed direction; the turntable 23 is slightly rotated; and the first shift cam 71 is moved so that the disc processor 20 is swung to become the clamp state again. Accordingly, with no need to detect the position in the standby state with an arrangement such as separately-provided sensor, the disc processor 20 can be placed in such a swinging state that the turntable 23 can be controlled to be slightly rotated during the double clamp operation in a simplified arrangement. Accordingly, the double clamp operation can be carried out with ease. A secure chucking is obtained without so-called clamp failures, so that the optical disc 1 can be favorably processed.

The first shift cam 71 restricts the swing of the disc processor 20 to place the disc processor 20 in such a processable state that the information processor 24 can conduct information processing on the optical disc 1 after the clamp state.

In other words, the swing of the disc processor 20 is restricted so that the disc processor 20 in such a processable state that the information processor 24 can conduct information processing on the optical disc 1. Accordingly, the turntable 23 in the standby state is substantially parallel to the inner surface of the casing 10. Consequently, for example, even while the turntable 23 is rotated during the double clamp process, a flat surface of the optical disc 1 having been chucked to the turntable 23 is not abutted to the inner surface of the casing 10. Therefore, a damage of the spindle motor caused by a load applied to the spindle motor due to abutment of the optical disc 1 to the casing 10 is prevented. Furthermore, the disc processor 20 in the standby state exhibits the same posture as in the processable state. Therefore, the clamper elevating groove 715 can be easily designed, thereby enhancing the manufacturability. In addition, since the postures are the same, control operation can be easily simplified.

In particular, the first shift cam 71 restricts the swing of the disc processor 20 so that the swing position of the disc processor 20 in the processable state is substantially the same as the swing position of the disc processor 20 in the standby state.

Thus, in a double clamp operation, for example, a simplified arrangement in which the clamper elevating groove 715 is provided with the standby section 715B can avoid problems caused by abutment of the optical disc 1 having been chucked to the turntable 23 to the casing 10. Accordingly, the clamper elevating groove 715 can be designed easily and is improved in manufacturability. The swing control can be also easily simplified.

The first shift cam 71 includes: an escape section 715A that holds the disc processor 20 when the disc processor 20 is swung into the escape state by the movement of the first shift cam 71 driven by the drive unit 40; the standby section 715B that is formed continuously from the escape section 715A and holds the disc processor 20 when the disc processor 20 is swung into the standby state by the movement of the first shift cam 71 driven by the drive unit 40; the clamp section 715C that is formed continuously from the standby section 715B and holds the disc processor 20 when the disc processor 20 is swung into the clamp state by the movement of the first shift cam 71 driven by the drive unit 40; and the in-process section 715D that is formed continuously from the clamp section 715C and holds the disc processor 20 when the disc processor 20 is swung into the processable state by the movement of the first shift cam 71 driven by the drive unit 40.

Accordingly, the first shift cam 71 for swinging the disc processor 20 so that the disc processor 20 can be securely clamped and favorably information processed can be easily obtained by simply forming the clamper elevating groove 715 as a continuation of the escape section 715A, the standby section 715B, the clamp section 715C, and the in-process section 715D, thereby easily enhancing the manufacturability. More specifically, the arrangement is so simplified as to only include the standby section 715B between the escape section 715A and the clamp section 715C. Therefore, the designability and the manufacturability can be easily improved, and the swing control can be also easily simplified.

In addition, the in-process section 715D and the standby section 715B are formed so that the swing position of the disc processor 20 in the processable state is substantially the same as the swing position of the disc processor 20 in the standby state.

Therefore, as set forth above, the clamper elevating groove 715 can be easily designed and is improved in manufacturability. The swing control can be also easily simplified.

The first shift cam 71 includes the clamper elevating groove 715 formed longitudinally along the moving direction. The disc processor 20 includes the clamper elevating pin 21C engageable with the clamper elevating groove 715. The clamper elevating groove 715 is provided with the escape section 715A, the standby section 715B, the clamp section 715C, and the in-process section 715D, all of which are continuously formed.

Accordingly, in order to easily control the swinging of the disc processor 20 without problems during a double clamp operation, the clamper elevating groove 715 provided to the swingable disc processor 20 is engaged with the clamper elevating groove 715 provided to the movable first shift cam 71. Thus, desirable clamp can be readily obtained, thereby improving manufacturability.

The first shift cam 71 swings the disc processor 20 by the total movement stroke in the moving direction.

Accordingly, the range in which the clamper elevating groove 715 is formable is widened. Consequently, the standby section 715B can be formed having enough length along the moving direction of the first shift cam 71. Therefore, the disc device 100 can securely conduct the double clamp operation while the size of the entire disc device 100 is kept compact.

Furthermore, the transfer unit 30 includes a cam pushing pin 613. When the optical disc 1 is transferred to the position to be clamped to the turntable 23, the cam pushing pin 613 pushes the first shift cam 71 toward the moving direction of the first shift cam 71. The first shift cam 71 starts moving when the cam pushing pin 613 pushes the first shift cam 71 with the drive force from the drive unit 40 being transmitted to the first shift cam 71.

With this arrangement, the drive force from the drive unit 40 is not transmitted to the first shift cam 71 before the transfer unit 30 transfers the optical disc 1 to the position where the optical disc 1 is clamped to the turntable 23. Accordingly, the transfer motion of the optical disc 1 by the transfer unit 30 and the swing motion of the disc processor 20 by the first shift cam 71 can be completely separated. As a consequence, the first shift cam 71 can devote the total movement stroke in the moving direction to the swing of the disc processor 20. Therefore, the disc device 100 can securely conduct the double clamp operation while the size of the entire disc device 100 is kept compact.

The drive unit 40 is disposed in the vicinity of a lateral wall of the casing 10 near a face of the casing 10 where the insertion-and-ejection opening 14 is provided. The drive unit 40 includes the drive motor 41 that generates drive force, the roller drive branch gear 423, and the shift drive branch gear 422. The roller drive branch gear 423 and the shift drive branch gear 422 are opposed to each other with a space interposed therebetween. A distal end of the first shift cam 71 in the moving direction is can advance into or retreat from the space.

Thus, a dead space provided between the roller drive branch gear 423 and the shift drive branch gear 422 is utilized as the space for the first shift cam 71 to advance in and retreat from. Accordingly, the total movement stroke of the first shift cam 71 can be extended. Consequently, the standby section 715B can be formed having an enough length along the moving direction of the first shift cam 71. Therefore, the disc device 100 can securely conduct the double clamp operation while the size of the entire disc device 100 is kept compact.

Incidentally, the disc device 100 preferably includes a standby-state detector disposed within the casing 10 for detecting an engagement position of the disc processor 20 with the first shift cam 71 to detect the standby state.

In the embodiment, the standby section 715B that keeps the disc processor 20 in the standby state is formed having an enough length along the moving direction of the first shift cam 71. Therefore, the double clamp movement can be easily conducted. In addition, since the standby section 715B has an enough length along the moving direction, the standby-state detector can be provided opposite to the standby section 715B. Accordingly, by detecting an engaged state of the clamper elevating pin 21C with the standby section 715B, the double clamp movement can even more securely be conducted.

The disc device 100 also includes the fourth switch SW4 disposed in the casing 10. The fourth switch SW4 detects an engagement position of the disc processor 20 with the first shift cam 71 to detect the processable state where the information processor 24 can conduct information processing on the optical disc 1.

Accordingly, judgment on whether in the processable state or not can be made based on information detected by the fourth switch SW4. Therefore, the information processing can be favorably conducted on the optical disc 1. In addition, by providing both of the fourth switch SW4 and the above-described standby-state detector, the engagement of the clamper elevating pin 21C sequentially established with the in-process section 715D, the clamp section 715C, and the standby section 715B during the second clamp operation can be detected by the switch SW4 and the standby-state detector. Therefore, the double clamp operation can be even more securely conducted.

The second shift cam for pivotally moving the disc processor 20 is provided on the link plate 55.

Accordingly, the clamper elevating pins 21C provided in pair on the base 21 can be respectively engaged with the first shift cam 71 and the second shift cam to pivotally move the disc clamper 70. Thus, the disc clamper 70 can be pivotally moved in a stable manner.

The base 21 of the disc processor 20 is swingably provided to the casing 10 in the vicinity of the insertion-and-ejection opening 14 and the left wall 10B via the floating rubber 21A. Accordingly, the swing range of the disc processor 20 near the front face 10A can be made smaller while and the swing range of the disc processor 20 near the turntable 23 can be made greater. In addition, the disc guide arm 53 is provided near the front face 10A where the swing range of the disc processor 20 is small. Accordingly, the disc guide arm 53 and the disc processor 20 can be disposed close to each other. Therefore, the thickness dimension of the disc device 100 can be reduced to promote downsizing.

### Modifications of Embodiment

It should be noted that the present invention is not limited to the exemplary embodiments described above, but may include modifications described below within a scope where an object of the present invention can be achieved.

Though the disc device 100 is exemplified as a thin disc device capable of being mounted on a notebook computer and the like, the present invention may be implemented on a relatively large disc device mounted on, for instance, desktop personal computer and the like.

Though a large-diameter disc 1A and a small-diameter disc 1B can be loaded in the casing 10 of the disc device 100 for information-processing, other arrangements are possible. For instance, the disc device may be adapted for more number of disc diameters. In this case, the movement of the link plate 55 is controlled in accordance with the respective disc diameters and the rotary angle of the loading arm 51, the disc guide arm 53, and the first and the second eject arms 61, 62 may be appropriately adjusted.

Alternatively, the loading arm 51 may not be moved in conjunction with the disc guide arm 53. In this case, the other drive unit for rotating the disc guide arm 53 in accordance with the diameter of the optical disc 1 may be provided to transfer the large-diameter disc 1A and the small-diameter disc 1B.

Though the disc processor 20 is pivotably attached near the insertion-and-ejection opening 14 and near the left wall 10B, other arrangement is possible. For instance, in a normal disc drive with no thickness limitation, an arrangement is possible where the pivotal displacement on the side of the insertion-and-ejection opening 14 is magnified or both of the sides of the insertion-and-ejection opening 14 and the turntable 23 may be pivotally moved in an equal level.

In the above embodiment, the first shift cam 71 is provided with the clamper elevating groove 715, and the disc processor 20 is provided with the clamper elevating pin 21C. However, an exchanged arrangement may be employed.

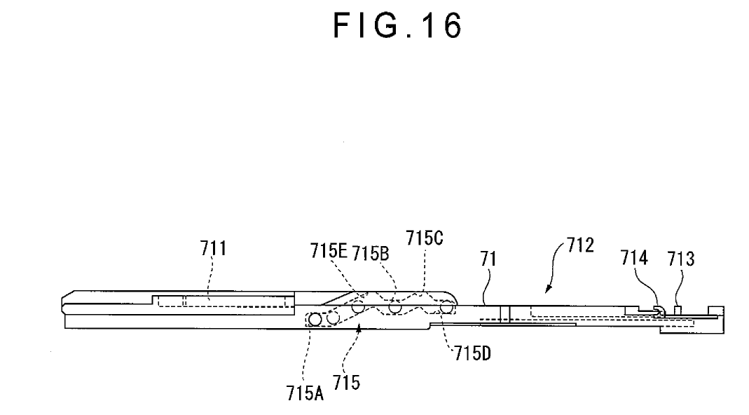

Furthermore, in the exemplary arrangement set forth above, the escape section 715A, the standby section 715B, the clamp section 715C, and the in-process section 715D are continuously formed, and the first shift cam 71 is temporarily moved in the opposite direction upon re-clamping process. However, a different arrangement may be employed, in which the first shift cam 71 is moved only in one direction, and the clamp state is established for plural times, namely twice, during the moving process of the first shift cam 71. More specifically, as exemplified in FIG. 16, the clamper elevating groove 715 may be provided continuously forming the escape section 715A, an initial clamp section 715E, the standby section 715B, the clamp section 715C, and the in-process section 715D. With this arrangement, the reverse operation is no longer required. The so-called double clamp is conducted in one motion, thereby facilitating the clamp process.

Also in the exemplary arrangement set forth above, the disc processor 20 engaged with the standby section 715B exhibits substantially the same posture as that of the disc processor 20 engaged with the in-process section 715D, but the disc processor 20 does not necessarily exhibit the same posture. It is only required that the turntable 23 is spaced apart from the inner surface of the casing 10 with respect to the clamp state, and this requirement may be fulfilled in any suitable manner.

Specific configurations and processes when implementing the present invention may be other configurations or the like as long as an object of the present invention can be attained.

### EFFECTS AND ADVANTAGES OF EMBODIMENTS

As set forth above, the disc device 100 of the embodiment includes: the casing 10; the drive unit 40; the disc processor 20 having the turntable 23, the spindle motor, the information processor 24 and swingably supported to the interior of the casing 10; and the first shift cam 71 driven by the drive unit 40 to swing the disc processor 20. The first shift cam 71 restricts the swing of the disc processor 20 so that the processor 20 becomes each of the escape state, the clamp state, and the standby state. The escape state is a state in which the turntable 23 is escaped from the transfer course. The clamp state is a state in which the optical disc 1 is clamped to the turntable 23 while being abutted to the inner face of the casing 10 opposite to the turntable 23. The standby state is a state in which the optical disc 1 clamped to the turntable 23 is allowed to keep a position apart from the opposing face of the casing 10 while the disc processor 20 is swung from the escape state to the clamp state.

With this arrangement, during the swinging of the disc processor 20 from the standby state to the clamp state with the first shift cam 71 being moved by the driving of the drive unit 40, the disc processor 20 can be maintained at a position where the swinging of the disc processor 20 is retrained (i.e., standby state) irrespective of the movement of the first shift cam 71. Therefore, if the clamp operation is to be conducted twice (i.e. a so-called double clamp operation), the first shift cam 71 only needs to be moved in the reverse direction as necessary such that the disc processor 20 becomes the standby state. Note that in a double clamp operation: the drive of the drive unit 40 is reversed; the first shift cam 71 is moved in a reversed direction; the turntable 23 is slightly rotated; and the first shift cam 71 is moved so that the disc processor 20 is swung to become the clamp state again. Accordingly, with no need to detect the position in the standby state with an arrangement such as separately-provided sensor, the disc processor 20 can be placed in such a swinging state that the turntable 23 can be controlled to be slightly rotated during the double clamp operation in a simplified arrangement. Accordingly, the double clamp operation can be carried out with ease. A secure chucking is obtained without so-called clamp failures, so that the optical disc 1 can be favorably processed.

### INDUSTRIAL APPLICABILITY

The present invention can be implemented in a disc device for processing disc recording mediums.

1. A disc device, comprising:
a casing with a slit-shaped opening through which a disc-shaped recording medium is adapted to be inserted and ejected;
a drive unit provided in the casing;
a traverse body comprising a turntable for detachably clamping the recording medium and an information processor that conducts an information processing comprising at least one of recording processing for recording information on the recording medium clamped on the turntable and reading processing for reading the information stored on the recording medium, the traverse body being supported in the casing and adapted to be swung so that the turntable advances to and retreats from a transfer course along which the recording medium inserted from the opening is transferred into the casing; and
a swing unit that is disposed in the casing, engaged with the traverse body, and moved by the drive unit to swing the traverse body, wherein
the swing unit restricts the swinging of the traverse body so that the traverse body becomes each of
an escape state in which the turntable is escaped from the transfer course,
a clamp state in which the recording medium is clamped to the turntable while being abutted to an inner surface of the casing opposite to the turntable, and
a standby state in which the recording medium clamped to the turntable can keep a position spaced apart from the inner surface of the casing while the traverse body is swung from the escape state to the clamp state.

2. The disc device according to claim 1, wherein
the swing unit restricts the swinging of the traverse body so that the traverse body becomes a processable state after the clamp state, the processable state being a state in which the information processor is capable of conducting an information processing on the recording medium.

3. The disc device according to claim 2, wherein
the swing unit restricts the swinging of the traverse body so that a swing position of the traverse body in the processable state is substantially the same as a swing position of the traverse body in the standby state.

4. The disc device according to claim 2, wherein
the swing unit comprises
an escape section that places the traverse body in the escape state by swinging the traverse body in conjunction with the movement of the swing unit driven by the drive unit,
a standby section that is formed continuously from the escape section and places the traverse body in the standby state by swinging the traverse body in conjunction with the movement of the swing unit driven by the drive unit,
a clamp section that is formed continuously from the standby section and places the traverse body in the clamp state by swinging the traverse body in conjunction with the movement of the swing unit driven by the drive unit, and
an in-process section that is formed continuously from the clamp section and places the traverse body in the processable state by swinging the traverse body in conjunction with the movement of the swing unit driven by the drive unit.

5. The disc device according to claim 4, wherein
the in-process section and the standby section are formed so that the swing position of the traverse body in the processable state is substantially the same as the swing position of the traverse body in the standby state.

6. The disc device according to claim 4, wherein
the swing unit comprises a clamper elevating groove formed longitudinally along a moving direction of the swing unit,
the traverse body comprises a clamper elevating pin that engages with the clamper elevating groove, and
the escape section, the standby section, the clamp section, and the in-process section are continuously provided to the clamper elevating groove.

7. The disc device according to claim 1, wherein
the swing unit swings the traverse body by a total movement stroke in the moving direction of the swing unit.

8. The disc device according to claim 1, wherein
a transfer unit comprises a pushing member that pushes the swing unit in the moving direction of the swing unit when the recording medium is transferred to a position where the recording medium is clamped to the turntable, and
the swing unit receives drive force from the drive unit when pushed by the pushing member and starts the movement.

9. The disc device according to claim 1, wherein
the drive unit comprises: a drive source that is disposed in the casing in the vicinity of a lateral wall adjacent to a surface on which the opening is provided, the drive source generating the drive force; a transfer-side transmission mechanism that is connected to the drive source and the transfer unit and transmits the drive force of the drive source to the transfer unit; and a swing-side transmission mechanism that is connected to the drive source and the swing unit and transmits the drive force of the dive source to the swing unit,
the transfer-side transmission mechanism and the swing-side transmission mechanism are opposed to each other with a space interposed therebetween, and
a distal end of the swing unit in the moving direction is capable of advancing to and retreating from the space.

10. The disc device according to claim 1, further comprising:
a standby-state detector that detects an engagement position of the traverse body with the swing unit to detect the standby state.

11. The disc device according to claim 1, further comprising:
an in-process state detector that is disposed in the casing and detects an engagement position of the traverse body with the swing unit to detect the processable state of the traverse body in which the information processor is capable of conducting the information processing on the recording medium.
